(19) United States
(12) Patent Application Publication
(10) Pub. No.: US 2021/0390747 A1
(43) Pub. Date: Dec. 16, 2021

(54) IMAGE FUSION FOR IMAGE CAPTURE AND PROCESSING SYSTEMS

(71) Applicant: QUALCOMM Incorporated, San Diego, CA (US)

(72) Inventors: Wen-Chun FENG, New Taipei City (TW); Yu-Chen HSU, Beitou Dist (TW); Yu-Ren LAI, Nantou County (TW)

(21) Appl. No.: 17/343,640

(22) Filed: Jun. 9, 2021

Related U.S. Application Data
(60) Provisional application No. 63/038,683, filed on Jun. 12, 2020.

(51) Int. Cl. G06T 11/60; G06T 3/40; G06T 3/00

(52) U.S. Cl. CPC G06T 11/60; G06T 3/0068; G06T 3/4015

(57) ABSTRACT

Techniques and systems are provided for processing image data. A first image having a first resolution can be obtained. In some aspects, the first image is generated based on a pixel binning process. A second image can be obtained having a second resolution that is greater than the first resolution. In some aspects, the second image is generated based on a remosaicing process. One or more weight maps can be generated based on characteristics determined based on pixels of the first image, pixels of the second image, or pixels of both the first image and the second image. A fused image can be generated based on the one or more weight maps that includes a first set of pixels from the first image and a second set of pixels from the second image.

### CROSS-REFERENCE TO RELATED APPLICATIONS

The present application claims the benefit of U.S. Provisional Application No. 63/038,683, filed Jun. 12, 2020, entitled “IMAGE FUSION FOR IMAGE CAPTURE AND PROCESSING SYSTEMS”, which is hereby incorporated by reference in its entirety and for all purposes.

### FIELD

This application is related to image processing. In some examples, aspect of this application relate to systems, apparatuses, methods, and computer-readable media providing an image fusion technique for image capture and processing systems.

### BACKGROUND

A camera is a device that receives light and captures image frames, such as still images or video frames, using an image sensor. Cameras may include processors, such as image signal processors (ISPs), that can receive one or more image frames and process the one or more image frames. For example, a raw image frame captured by a camera sensor can be processed by an ISP to generate a final image. Cameras can be configured with a variety of image capture and image processing settings to alter the appearance of an image. Some camera settings are determined and applied before or during capture of the photograph, such as ISO, exposure time, aperture size, f/stop, shutter speed, focus, and gain. Other camera settings can configure post-processing of a photograph, such as alterations to contrast, brightness, saturation, sharpness, levels, curves, or colors.

### SUMMARY

Systems and techniques are described herein for providing image fusion for generating super resolution images. According to one illustrative example, a method of processing image data is provided. The method includes: obtaining a first image having a first resolution; obtaining a second image having a second resolution that is greater than the first resolution; generating one or more weight maps based on characteristics determined based on pixels of the first image, pixels of the second image, or pixels of both the first image and the second image; and generating, based on the one or more weight maps, a fused image including a first set of pixels from the first image and a second set of pixels from the second image.

In another example, an apparatus for processing image data is provided that includes a memory configured to store at least one image and one or more processors implemented in circuitry and coupled to the memory. The one or more processors are configured to and can: obtain a first image having a first resolution; obtain a second image having a second resolution that is greater than the first resolution; generate one or more weight maps based on characteristics determined based on pixels of the first image, pixels of the second image, or pixels of both the first image and the second image; and generate, based on the one or more weight maps, a fused image including a first set of pixels from the first image and a second set of pixels from the second image.

In another example, a non-transitory computer-readable medium is provided that has stored thereon instructions that, when executed by one or more processors, cause the one or more processors to: obtain a first image having a first resolution; obtain a second image having a second resolution that is greater than the first resolution; generate one or more weight maps based on characteristics determined based on pixels of the first image, pixels of the second image, or pixels of both the first image and the second image; and generate, based on the one or more weight maps, a fused image including a first set of pixels from the first image and a second set of pixels from the second image.

In another example, an apparatus for processing image data is provided. The apparatus includes: means for obtaining a first image having a first resolution; obtaining a second image having a second resolution that is greater than the first resolution; means for generating one or more weight maps based on characteristics determined based on pixels of the first image, pixels of the second image, or pixels of both the first image and the second image; and means for generating, based on the one or more weight maps, a fused image including a first set of pixels from the first image and a second set of pixels from the second image.

In some aspects, the method, apparatuses, and computer-readable medium described above further comprise: determining, based on the one or more weight maps, the first set of pixels from the first image and the second set of pixels from the second image.

In some aspects, the first image is generated based on a pixel binning process and the second image is generated based on a remosaicing process.

In some aspects, the first image and the second image are obtained from a same image sensor.

In some aspects, the method, apparatuses, and computer-readable medium described above further comprise: downsampling the second image to the first resolution; and aligning the first image and the downsampled second image. In some cases, a weight map of the one or more weight maps is generated using the downsampled second image.

In some aspects, aligning the first image and the downsampled second image includes: extracting one or more feature points from the first image and one or more feature points from the downsampled second image; determining a shift and a rotation using a transform matrix, the one or more feature points from the first image, and the one or more feature points from the second image; and applying the shift and the rotation to one of the first image or the downsampled second image to align the first image and the second image.

In some aspects, the first set of pixels are selected from the first image based on the one or more weight maps including highest weight values for the first set of pixels, and wherein the second set of pixels are selected from the second image based on the one or more weight maps including highest weight values for the second set of pixels.

In some aspects, the characteristics include respective gradient values for the pixels of the first image and the pixels of the second image, and wherein the one or more weight maps include values representative of the respective gradient values for the pixels of the first image and the pixels of the second image.

In some aspects, the values of the one or more weight maps are normalized values generated based on the respective gradient values for the pixels of the first image and the pixels of the second image.

In some aspects, the characteristics include respective gradient values for the pixels of the first image and the pixels of the second image, and generating the one or more weight maps includes: determining a first weight map for the first image, the first weight map including a respective value representative of a respective gradient value determined for each pixel of the first image; and determining a second weight map for the second image, the second weight map including a respective value representative of a respective gradient value determined for each pixel of the second image.

In some aspects, the method, apparatuses, and computer-readable medium described above further comprise: generating the first weight map and the second weight map based on comparing a gradient value for each pixel from the first image with a gradient value for each corresponding pixel from the second image.

In some aspects, the method, apparatuses, and computer-readable medium described above further comprise: comparing a first gradient value of a first pixel of the first image and a second gradient value of a second pixel of the second image; determining the first gradient value is greater than the second gradient value; and based on determining the first gradient value is greater than the second gradient value, assigning a first value to a first location in the first weight map and a second value to a second location in the second weight map, the first value indicating use of the first pixel from the first image in the fused image.

In some aspects, the method, apparatuses, and computer-readable medium described above further comprise: comparing a first gradient value of a first pixel of the first image and a second gradient value of a second pixel of the second image; determining the first gradient value is greater than the second gradient value; and based on determining the first gradient value is greater than the second gradient value, assigning a first value to a first location in the first weight map and a second value to a second location in the second weight map, the first value indicating a higher weighting assigned to the first pixel of the first image relative to the second pixel of the second image in the fused image.

In some aspects, the method, apparatuses, and computer-readable medium described above further comprise: generating the first image by applying a pixel binning process to a first set of received image data.

In some aspects, generating the first image by applying the pixel binning process to the first set of received image data includes: obtaining the first set of received image data, the first set of received image data being captured using a quad color filter array; merging multiple red pixels from the quad color filter array into a single red pixel; merging multiple green pixels from the quad color filter array into a single green pixel; and merging multiple blue pixels from the quad color filter array into a single blue pixel.

In some aspects, the method, apparatuses, and computer-readable medium described above further comprise: generating the second image by applying the remosaicing process to a second set of received image data.

In some aspects, generating the second image by applying a remosaicing process to the second set of received image data includes: obtaining the second set of received image data, the second set of received image data being captured using a quad color filter array; and converting the quad color filter array to a Bayer array.

In some aspects, the apparatuses described above include or are a part of a camera, a mobile device (e.g., a mobile telephone or so-called “smart phone” or other mobile device), a wearable device, an extended reality device (e.g., a virtual reality (VR) device, an augmented reality (AR) device, or a mixed reality (MR) device), a personal computer, a laptop computer, a server computer, or other device. In some aspects, the apparatus includes a camera or multiple cameras for capturing one or more images. In some aspects, the apparatus further includes a display for displaying one or more images, notifications, and/or other displayable data.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1 is a block diagram illustrating an example architecture of an image capture and processing system, in accordance with some examples;

FIG. 2 is a diagram illustrating an example of a quad color filter array;

FIG. 3 is a diagram illustrating an example of a binning pattern resulting from application of a binning process to a quad color filter array;

FIG. 4A is a diagram illustrating an example of a quad color filter array pattern remosaiced to a Bayer color filter array pattern;

FIG. 4B, FIG. 4C1, FIG. 4C2, and FIG. 4D are diagrams illustrating examples of remosaicing processes used to remosaic a quad color filter array to a Bayer color filter array pattern;

FIG. 5A and FIG. 5B are diagrams illustrating different advantages provided by binned images and remosaiced images;

FIG. 6A is a diagram illustrating a 12 megapixel (MP) binned image;

FIG. 6B is a diagram illustrating a 48 MP remosaiced image;

FIG. 7 is a system diagram illustrating an example of a system including a super resolution processing engine that can perform fusion techniques, in accordance with some examples;

FIG. 8 is a diagram illustrating an example of a super resolution processing engine, in accordance with some examples;

FIG. 9 is a diagram illustrating an example of components and operation of an image alignment system of a super resolution processing engine, in accordance with some examples;

FIG. 10A, FIG. 10B, FIG. 10C, and FIG. 10D are diagrams illustrating example operations of a weight map generation engine of an image fusion system of a super resolution processing engine, in accordance with some examples;

FIG. 11 is a diagram illustrating example operations of an image fusion engine of an image fusion system of a super resolution processing engine, in accordance with some examples;

FIG. 12 is a diagram illustrating an example of a system that can be used to extend the image fusion techniques described herein from a luma-chrominance (YUV) color domain to a Bayer domain, in accordance with some examples;

FIG. 13A, FIG. 13B, and FIG. 13C are diagrams illustrating an example of a system that can extend the image fusion techniques described herein to be used for cases in which zoom is performed, in accordance with some examples;

FIG. 14 is a diagram illustrating an example of a system that can extend the image fusion techniques described herein for multiple image sensors, in accordance with some examples;

FIG. 15A through FIG. 15C, FIG. 16A through FIG. 16C, and FIG. 17A through FIG. 17C are images illustrating results of performing the image fusion techniques described herein;

FIG. 18 is a flow diagram illustrating an example of a process for processing image data, in accordance with some examples; and

FIG. 19 is a diagram illustrating an example of a system for implementing certain aspects described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

An image capture device (e.g., a camera or a device including a camera) is a device that receives light and captures image frames, such as still images or video frames, using an image sensor. The terms “image,” “image frame,” and “frame” are used interchangeably herein. Cameras of image capture devices can be configured with a variety of image capture and image processing settings. The different settings result in images with different appearances. Some camera settings are determined and applied before or during capture of one or more image frames, such as ISO, exposure time, aperture size, f/stop, shutter speed, focus, and gain. For example, settings or parameters can be applied to an image sensor for capturing the one or more image frames. Other camera settings can configure post-processing of one or more image frames, such as alterations to contrast, brightness, saturation, sharpness, levels, curves, or colors. For example, settings or parameters can be applied to a processor (e.g., an image signal processor or ISP) for processing the one or more image frames captured by the image sensor.

Cameras may include or be in communication with processors, such as ISPs, that can receive one or more image frames from an image sensor and process the one or more image frames. For instance, a raw image frame captured by a camera sensor can be processed by an ISP to generate a final image. In some examples, an ISP can process an image frame using a plurality of filters or processing blocks that are applied to the captured image frame, such as demosaicing, gain adjustment, white balance adjustment, color balancing or correction, gamma compression, tone mapping or adjustment, denoising or noise filtering, edge enhancement, contrast adjustment, intensity adjustment (such as darkening or lightening), among others. In some examples, an ISP can include a machine learning system (e.g., one or more neural networks and/or other machine learning components) that can process an image frame and output a processed image frame.

In many camera systems, a host processor (HP) (also referred to as an application processor (AP) in some cases) is used to dynamically configure an image sensor with new parameter settings. The HP is also used to dynamically configure parameter settings of an ISP pipelines to match the exact settings of an input image sensor frame so that the image data is processed correctly.

Systems, apparatuses, processes (also referred to as methods), and computer-readable media (collectively referred to as “techniques”) are described herein for providing image fusion for generating super resolution images. For instance, in some examples, different types of images of a scene can be captured by an image sensor, and a super resolution processing pipeline can select pixels from the images to include in an output image (referred to as a fused image) based on one or more weight maps generated for the multiple images. In some cases, the weight maps can be generated based on characteristics (e.g., gradient information or other characteristics) of the multiple images. Examples of images of different types include binned images (generated using a binning technique or process) and remosaiced images (generated using a remosaicing technique or process). Each of the different types of images can provide various advantages. For instance, a remosaiced image can have a higher resolution and thus more details, while a binned image can have higher sensitivity with low noise levels. Selecting pixels from the different images to include in a fused image allows the fused image to benefit from the advantages provided by the different types of images. In some implementations, the techniques described herein can be performed on image data captured and output by an image sensor, in which cases the techniques are referred to as an “in-sensor” process, and the processed data can be output to an ISP or other image processing device. For example, as described below, an image sensor is used to capture image raw data and can output the raw image data as a binning image and/or as remosaiced image. As further described below, image fusion can be calculated by an image processing device (e.g., an ISP) to fuse different types of images. The “in-sensor” process means the proposed techniques can be directly applied to and can alter the output raw data captured by image sensor before the image processing device (e.g., ISP). Various aspects of the techniques described herein will be discussed below with respect to the figures.

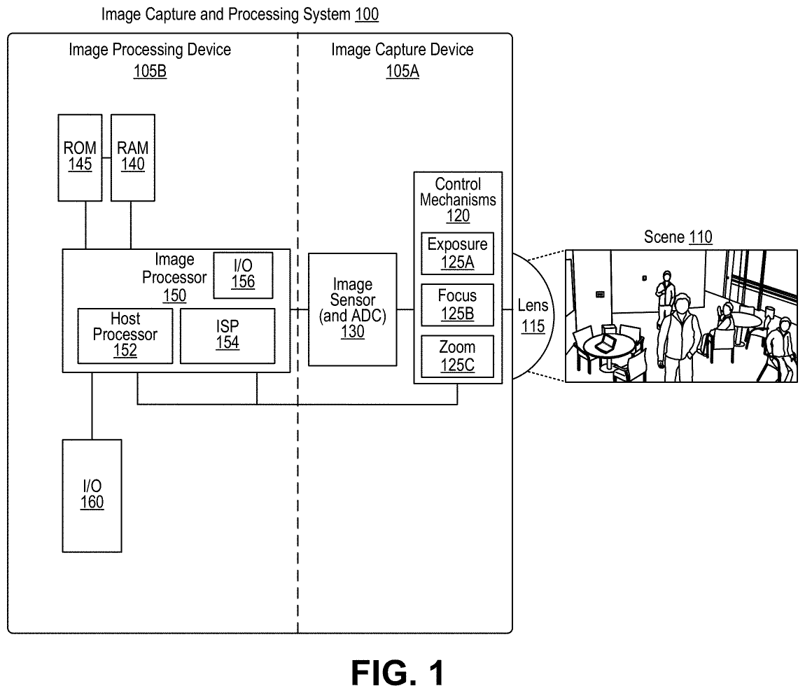

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. A lens 115 of the image capture and processing system 100 faces a scene 110 and receives light from the scene 110. The lens 115 bends the light toward the image sensor 130. The light received by the lens 115 passes through an aperture controlled by one or more control mechanisms 120 and is received by an image sensor 130.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the image capture and processing system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

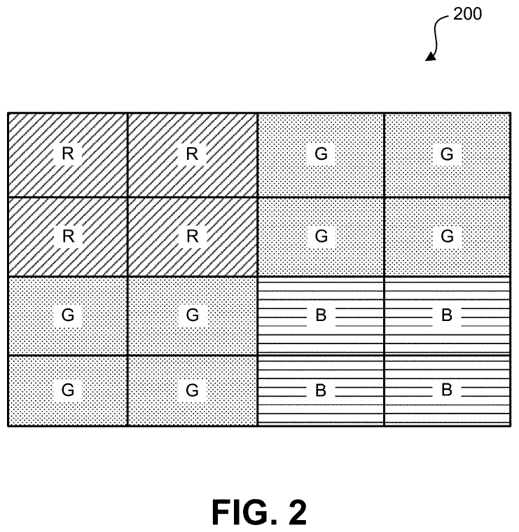

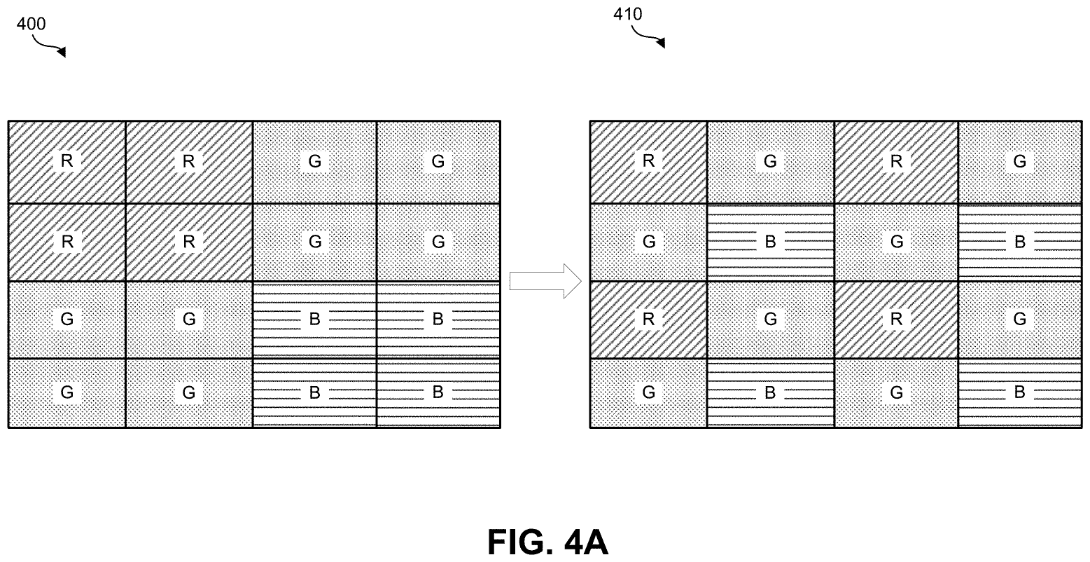

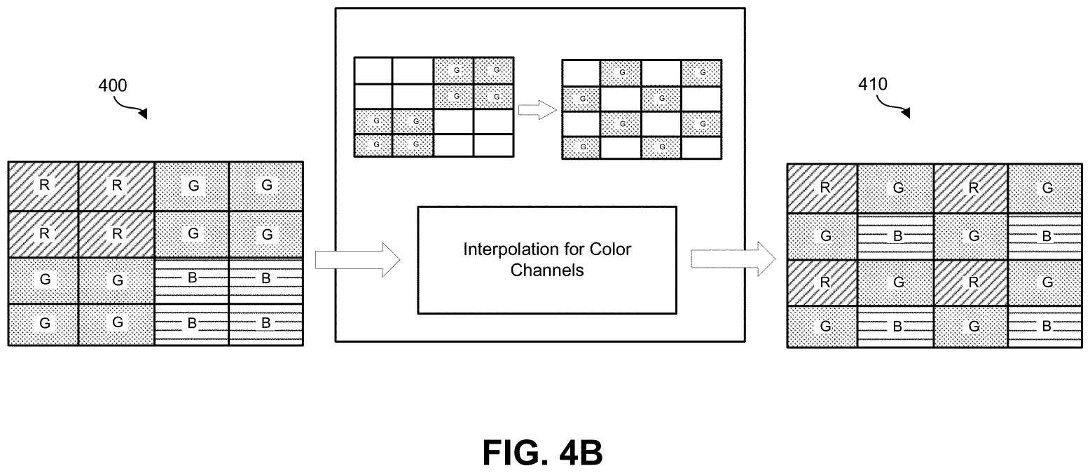

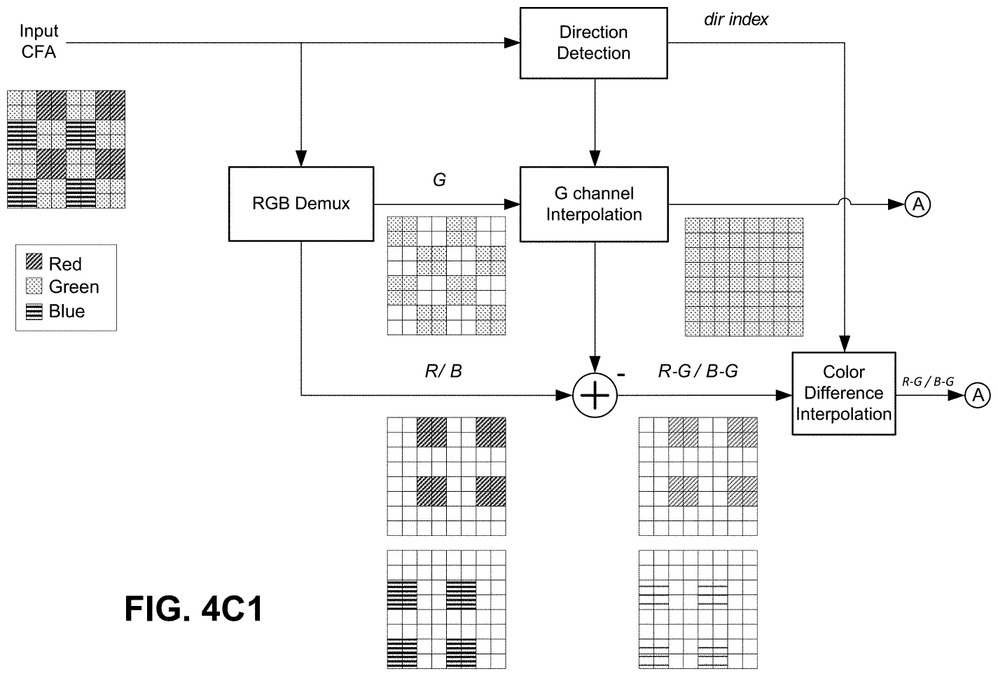

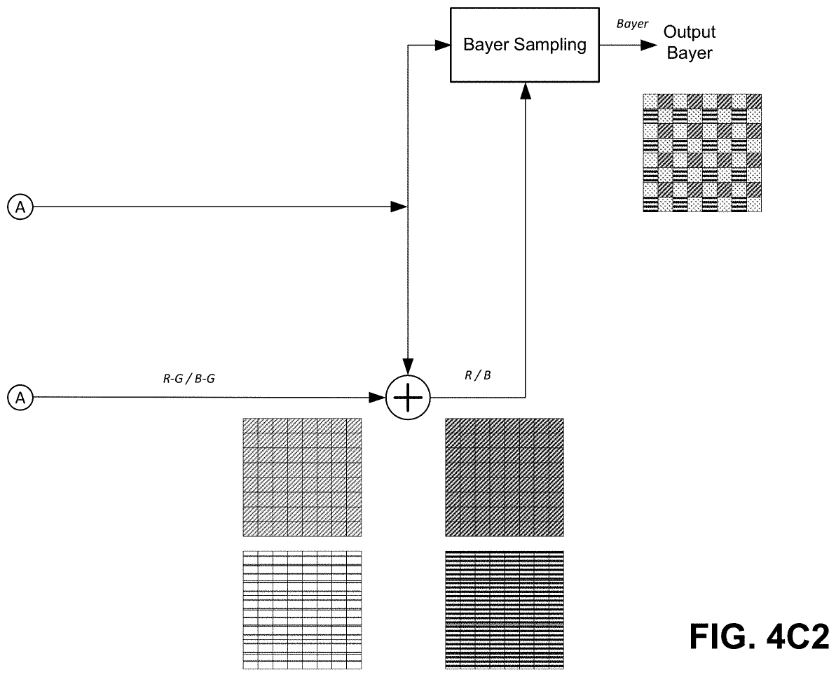

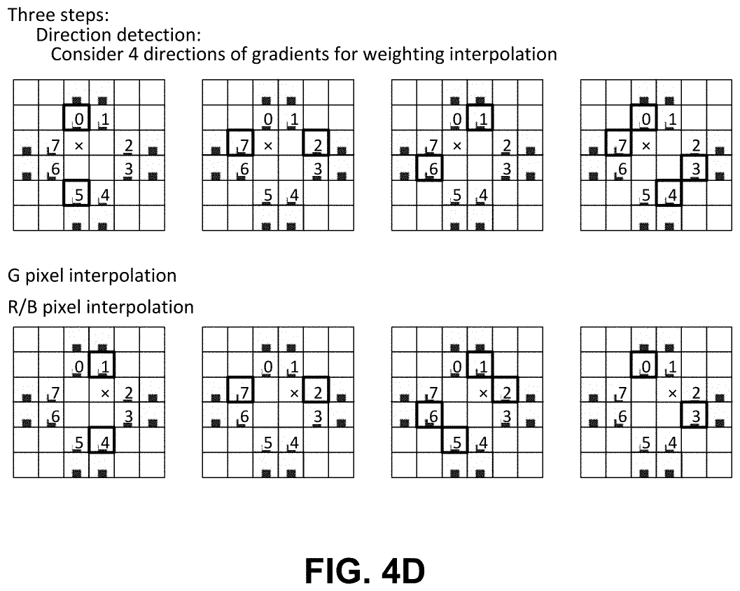

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters of a color filter array, and may thus measure light matching the color of the color filter covering the photodiode. Various color filter arrays can be used, including a Bayer color filter array, a quad color filter array (also referred to as a quad Bayer filter), and/or other color filter array. FIG. 2 is a diagram illustrating an example of a quad color filter array 200. As shown, the quad color filter array 200 includes a 2×2 (or “quad”) pattern of color filters, including a 2×2 pattern of red (R) color filters, a pair of 2×2 patterns of green (G) color filters, and a 2×2 pattern of blue (B) color filters. The pattern of the quad color filter array 200 shown in FIG. 2 is repeated for the entire array of photodiodes of a given image sensor. An example of a Bayer color filter array 410 is shown in FIG. 4A. As shown, the Bayer color filter array includes a repeating pattern of red color filters, blue color filters, and green color filters. Using either quad color filter array or the Bayer color filter array, each pixel of an image is generated based on red light data from at least one photodiode covered in a red color filter of the color filter array, blue light data from at least one photodiode covered in a blue color filter of the color filter array, and green light data from at least one photodiode covered in a green color filter of the color filter array. Other types of color filter arrays may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more image signal processors (ISPs) (including ISP 154), one or more host processors (including host processor 152), and/or one or more of any other type of processor 1910 discussed with respect to the computing system 1900. The host processor 152 can be a digital signal processor (DSP) and/or other type of processor. The image processor 150 may store image frames and/or processed images in random access memory (RAM) 140/1920, read-only memory (ROM) 145/1925, a cache 1912, a memory unit 1915, another storage device 1930, or some combination thereof.

In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The host processor 152 of the image processor 150 can configure the image sensor 130 with parameter settings (e.g., via an external control interface such as I2C, I3C, SPI, GPIO, and/or other interface). In one illustrative example, the host processor 152 can update exposure settings used by the image sensor 130 based on internal processing results of an exposure control algorithm from past image frames. The host processor 152 can also dynamically configure the parameter settings of the internal pipelines or modules of the ISP 154 to match the settings of one or more input image frames from the image sensor 130 so that the image data is correctly processed by the ISP 154. Processing (or pipeline) blocks or modules of the ISP 154 can include modules for lens/sensor noise correction, de-mosaicing, color conversion, correction or enhancement/suppression of image attributes, denoising filters, sharpening filters, among others. For example, the processing blocks or modules of the ISP 154 can perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The settings of different modules of the ISP 154 can be configured by the host processor 152.

The image processing device 105B can include various input/output (I/O) devices 160 connected to the image processor 150. The I/O devices 160 can include a display screen, a keyboard, a keypad, a touchscreen, a trackpad, a touch-sensitive surface, a printer, any other output devices 1935, any other input devices 1945, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

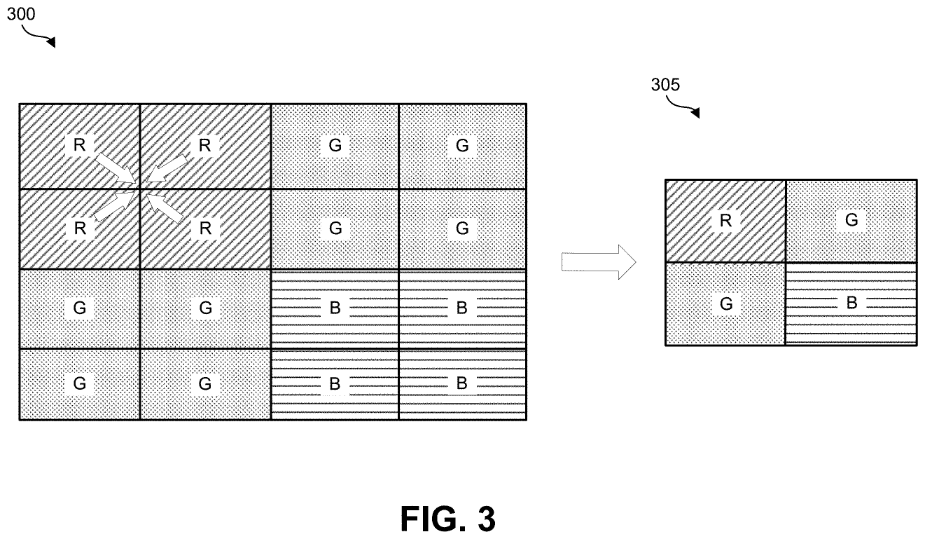

As noted above, a color filter array can cover the one or more arrays of photodiodes (or other photosensitive elements) of the image sensor 130. The color filter array can include a quad color filter array in some implementations, such as the quad color filter array 200 shown in FIG. 2. In certain situations, after an image is captured by the image sensor 130 (e.g., before the image is provided to and processed by the ISP 154), the image sensor 130 can perform a binning process to bin the quad color filter array 200 pattern into a binned Bayer pattern. For instance, as shown in FIG. 3 (described below), the quad color filter array 200 pattern can be converted to a Bayer color filter array pattern (with reduced resolution) by applying the binning process. The binning process can increase signal-to-noise ratio (SNR), resulting in increased sensitivity and reduced noise in the captured image. In one illustrative example, binning can be performed in low-light settings when lighting conditions are poor, which can result in a high quality image with higher brightness characteristics and less noise.

FIG. 3 is a diagram illustrating an example of a binning pattern 305 resulting from application of a binning process to the quad color filter array 300. The example illustrated in FIG. 3 is an example of a binning pattern 305 that results from a 2×2 quad color filter array binning process, where an average of each 2×2 set of pixels in the quad color filter array 300 results in one pixel in the binning pattern 305. For example, an average of the four pixels captured using the 2×2 set of red (R) color filters in the quad color filter array 300 can be determined. The average R value can be used as the single R component in the binning pattern 305. An average can be determined for each 2×2 set of color filters of the quad color filter array 300, including an average of the top-right pair of 2×2 green (G) color filters of the quad color filter array 300 (resulting in the top-right G component in the binning pattern 305), the bottom-left pair of 2×2 G color filters of the quad color filter array 300 (resulting in the bottom-left G component in the binning pattern 305), and the 2×2 set of blue (B) color filters (resulting in the B component in the binning pattern 305) of the quad color filter array 300.

The size of the binning pattern 305 is a quarter of the size of the quad color filter array 300. As a result, a binned image resulting from the binning process is a quarter of the size of an image processed without binning. In one illustrative example where a 48 megapixel (48 MP or 48 M) image is captured by the image sensor 130 using a 2×2 quad color filter array 300, a 2×2 binning process can be performed to generate a 12 MP binned image. The reduced-resolution image can be upsampled (upscaled) to a higher resolution in some cases (e.g., before or after being processed by the ISP 154).

In some examples, when binning is not performed, a quad color filter array pattern can be remosaiced (using a remosaicing process) by the image sensor 130 to a Bayer color filter array pattern. For example, the Bayer color filter array is used in many ISPs. To utilize all ISP modules or filters in such ISPs, a remosaicing process may need to be performed to remosaic from the quad color filter array 300 pattern to the Bayer color filter array pattern. The remosaicing of the quad color filter array 300 pattern to a Bayer color filter array pattern allows an image captured using the quad color filter array 300 to be processed by ISPs that are designed to process images captured using a Bayer color filter array pattern.

FIG. 4A is a diagram illustrating an example of a quad color filter array 400 pattern remosaiced to a Bayer color filter array 410 pattern. FIG. 4B, FIG. 4C1, FIG. 4C2, and FIG. 4D are diagrams illustrating examples of remosaicing processes used to remosaic the quad color filter array 400 to the Bayer color filter array 410 pattern. The remosaicing process can be based on an interpolation performed using the various color values of an image captured using the quad color filter array 400. For example, all insufficient pixels for all color channels can be interpolated to generate the Bayer color filter array 410. In some cases, as illustrated in FIG. 4B, FIG. 4C1, FIG. 4C2, and FIG. 4D, the remosaicing process can be used to interpolate each channel (e.g., each of the R, G, and B channels) considering the direction of gradient. In quad color filter array (QCFA) remosaicing, the G channel will be interpolated and then the R and B channels. Afterwards, the Bayer pattern is output. The example shown in FIG. 4B provides an example of the green color values from the quad color filter array 400 being used to interpolate green values for the green pixels of the Bayer color filter array 410 pattern. The interpolation can be performed by the image sensor 130. Each manufacturer (e.g., original equipment manufacturer or OEM) of a camera device (e.g., a mobile device with one or more cameras, etc.) can have its own sensor design, in which case different sensors can perform different types of interpolation to the quad color filter array 400 pattern to generate the Bayer color filter array 410 pattern.

The remosaiced image size is equal to the size of the image captured using the quad color filter array 400. For example, a 48 MP image captured by the image sensor 130 using the quad color filter array 400 pattern can be remosaiced to a 48 MP image having the Bayer color filter array 410 pattern. The 48 MP image having the Bayer pattern can be provided to the ISP 154 for processing (e.g., demosaicing, gain adjustment, white balance adjustment, color balancing or correction, gamma compression, etc.).

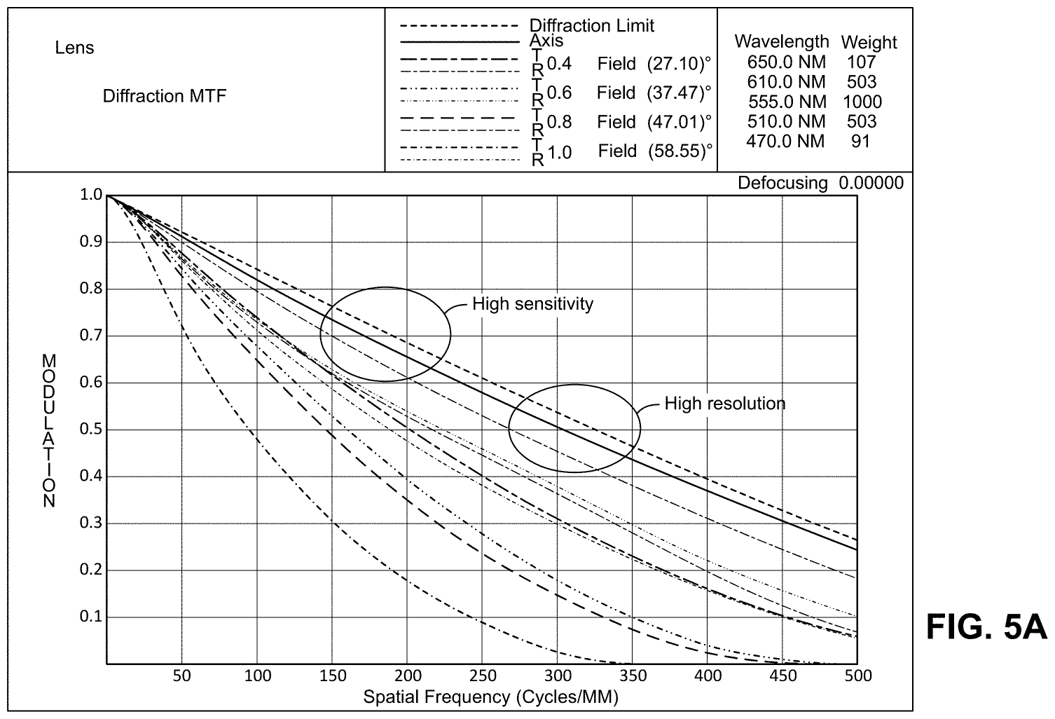

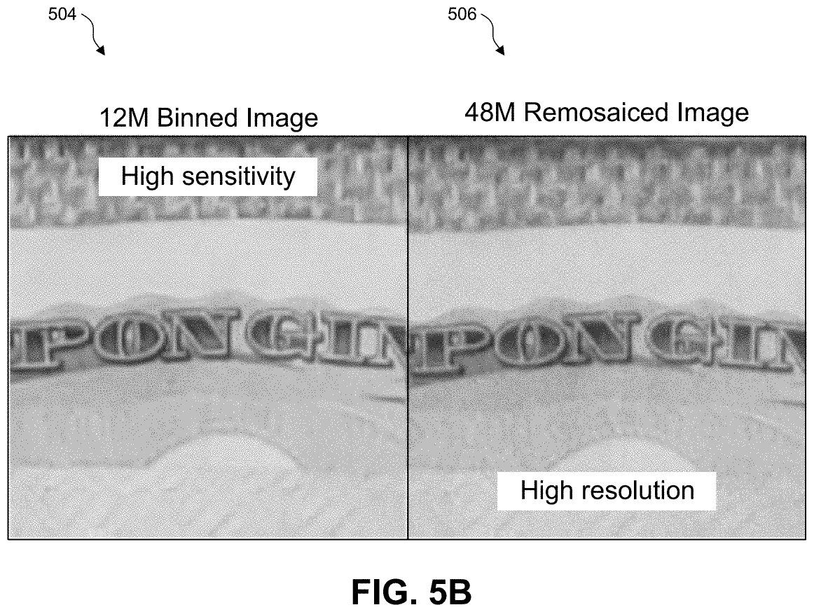

FIG. 5A and FIG. 5B are diagrams illustrating different advantages provided by binned images and remosaiced images. As shown in the graph 502 of FIG. 5A, the spatial sampling frequency is different between a remosaiced image and a binned image. For example, assuming a pixel size of a 48 MP remosaiced image is 0.8 micrometers (μm) (also referred to as a micron), after binning, the pixel size of a 12 MP binned image becomes 1.6 μm. The resolution of an image increases as the spatial sampling frequency increases (as is the case for the 48 MP remosaiced image 506 in FIG. 5B), while sensitivity is higher for lower spatial resolution (as is the case for the 12 MP binned image 504 of FIG. 5A). As illustrated in FIG. 5B, a 48M remosaiced image 506 has a higher resolution and thus more details as compared to a 12M binned image 504, while the 12M binned image 504 has higher sensitivity with lower noise levels than the 48M remosaiced image 506.

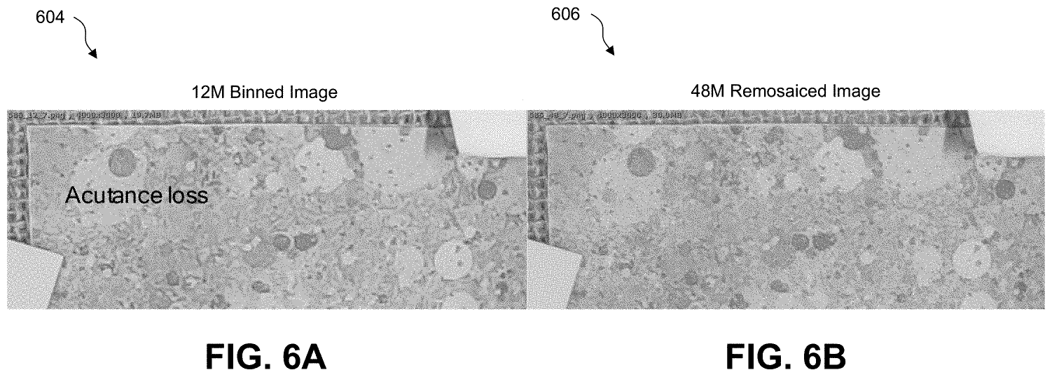

Acutance is a subjective perception or measure of sharpness (related to the edge contrast) of an image. Image detail is reduced or eliminated based on binning. As a result, a loss in acutance occurs in a binned image captured by an image sensor using a quad color filter array. FIG. 6A is a diagram illustrating a 12 MP binned image 604 and FIG. 6B is a diagram illustrating a 48 MP remosaiced image 606. As shown, acutance loss is present in the binned image 604, which is perceived as a loss of sharpness (less edge contrast). Conventional techniques for solving the problem of acutance loss is to decrease the noise reduction level and enhance the image (based on a trade-off between texture and noise). Because of the trade-off between texture and noise, the noise increases as the texture of the image is enhanced.

As noted above, systems and techniques are described herein for providing image fusion for generating super resolution images. The systems and techniques can be used to fuse any types of images by combining pixels of the images to produce a fused image. Fusion of binned images and remosaiced images are described herein for illustrative purposes. However, the image fusion techniques can be used to combine pixels of other types of images. In some cases, the image fusion techniques can be implemented as an in-sensor process performed on the data output by an image sensor (e.g., image sensor 130) to generate a fused image. The fused image can then be output by the image sensor to an ISP (e.g., ISP 154) or other processing device. In some cases, the fusion can be performed by the ISP (e.g., the ISP 154).

The systems and techniques described herein can implement the image fusion technique using a super resolution processing engine or pipeline. The super resolution processing engine can process multiple images of different types that capture a scene. In one illustrative example, an image of a scene captured by an image sensor using a quad color filter array (e.g., the quad color filter array 200) can be binned to generate a 12 MP binned image and can be remosaiced to generate a 48 MP remosaiced image. The super resolution processing engine can generate one or more weight maps for the 12 MP binned image and the 48 MP remosaiced image, and can select pixels from the 12 MP binned image and pixels from the 48 MP remosaiced image to include in a fused image based on the one or more weight maps generated for the images. For example, the super resolution processing engine can choose a pixel from a common location in the images that has a larger weight value to include in the fused image.

The systems and techniques described herein can increase the quality of images by combining the advantages of different types of images. For example, the fusion techniques can increase acutance in output images while preserving the contrast in the images by combining the advantages of remosaiced images and binned images. Further, as noted above, the spatial sampling frequency is different between remosaiced images and binned images. By fusing images (e.g., fusing remosaiced images and binned images by image sensor 130), the systems and techniques described herein can generate a fused image that includes textures from different spatial frequency domains of the lens.

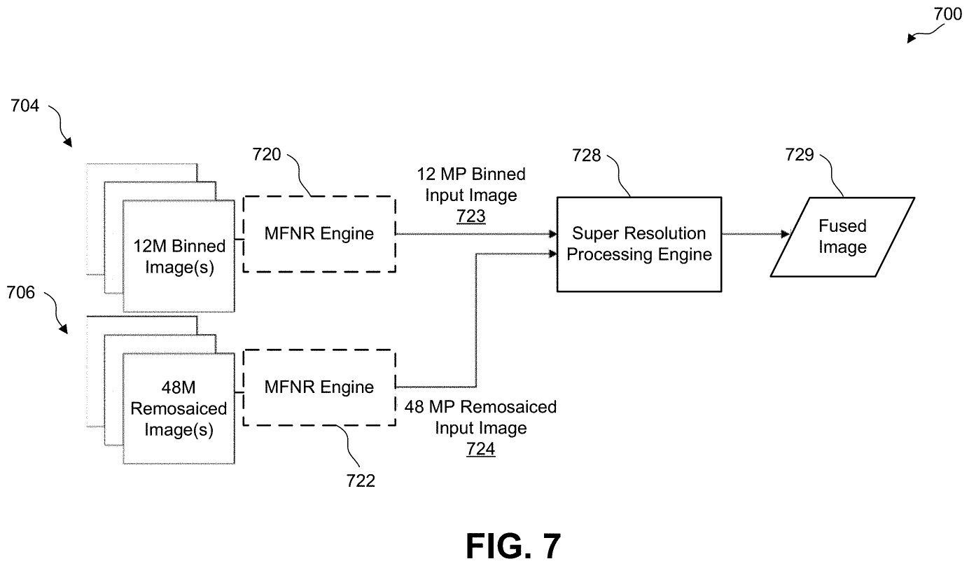

FIG. 7 is a system diagram illustrating an example of a system 700 including a super resolution processing engine 728 that can perform the fusion techniques descried herein. In the example illustrated in FIG. 7, one or more 12 megapixel (12M or 12 MP) binned images 704 are input to a multi-frame noise reduction (MFNR) engine 720, and one or more 48 MP remosaiced images 706 are input to an MFNR engine 722. For simplicity and explanation purposes, the one or more 12 MP binned images 704 will be referenced herein as a 12 MP binned image 704 (in singular form) and the one or more 48 MP remosaiced images 706 will be referenced herein as a 48 MP remosaiced image 706. However, one of ordinary skill will recognize that the one or more 12 MP binned images 704 can include a single image or multiple images, and the one or more 48 MP remosaiced images 706 can include a single image or multiple images. In some cases, a single MFNR engine (MFNR engine 720 or 722) can perform MFNR for both the 12 MP binned image 704 and the 48 MP remosaiced image 706.

The MFNR engine 720 and the MFNR engine 722 can be embedded in an image sensor (e.g., image sensor 130) and can process images captured by the image sensor to enhance the images. For example, MFNR can be used to enhance images taken in low-light scenes and can minimize the noise in order to produce images that are bright with low or no noise (as opposed to dark and grainy images that are typically produced in low-light scenes). In some examples, the image sensor can generate multiple 12 MP binned images of a scene and can process 12 MP binned images using the MFNR engine 720, which can reduce the noise in the 12 MP binned images and then combine the 12 MP binned images into a single image. The output of the MFNR engine 720 is shown as a 12 MP binned input image 723 that is input to the super resolution processing engine 728. In some examples, the image sensor can generate multiple 48 MP remosaiced images of the scene and can process the 48 MP remosaiced images using the MFNR engine 722 to reduce the noise in the 48 MP remosaiced images and then combine the 48 MP remosaiced images into a single image. The output of the MFNR engine 722 is shown as a 48 MP remosaiced input image 724 that is input to the super resolution processing engine 728. The MFNR engines 720 and 722 are optional, and in some implementations can be omitted or not used by the system 700. In such implementations, the 12 MP binned image 704 can be provided as the 12 MP binned input image 723 and the 48 MP remosaiced image 706 can be provided as the 48 MP remosaiced input image 724 to the super resolution processing engine 728.

The super resolution processing engine 728 can perform image fusion to fuse the 12 MP binned input image 723 and the 48 MP remosaiced input image 724 in order to generate a fused image 729. The super resolution processing engine 728 can generate one or more weight maps for the 12 MP binned input image 723 and the 48 MP remosaiced input image 724. In some cases, the one or more weight maps can be generated based on characteristics of the images. In one illustrative example, the characteristics can include gradient information, in which case the weights in the one or more weight maps are determined based on gradient values that are determined for the pixels in the images. In some cases, a weight map determined based on gradient values can also be referred to as a gradient map. In some cases, a motion map can be combined with the gradient map to determine which pixel is chosen for fusion. For instance, the motion map can be generated by calculating the difference between two input images (e.g., using optical flow techniques or other techniques). If an object is moving between two input images, the difference, called motion, between two corresponding pixels of the moving object is large. In some implementations, pixels belonging to the moving object may be excluded from fusion to avoid generating artifacts. For example, if the motion indicated in the motion map for a particular pixel or group of pixels exceeds a threshold value, the super resolution processing engine may select a corresponding pixel from either the 12 MP binned image 723 or the 48 MP remosaiced input image 724, regardless of the values in the weight maps.

In some examples, a weight map can be generated for each image (e.g., a first weight map for the 12 MP binned input image 723 and a second weight map for the 48 MP remosaiced input image 724). In some examples, a single weight map can be generated for the images (e.g., a single weight map for the 12 MP binned input image 723 and the 48 MP remosaiced input image 724). The super resolution processing engine 728 can select pixels from the 12 MP binned input image 723 and the 48 MP remosaiced input image 724 to include in the fused image 729 based on the one or more weight maps. For example, the super resolution processing engine 728 can choose a pixel from a common location in the images (e.g., a pixel at a location (0,0) in the 12 MP binned input image 723 and a pixel at a location (0,0) in the 48 MP remosaiced input image 724) that has a larger weight value (e.g., corresponding to a larger gradient or other characteristic) to generate the fused image 729. Further details regarding the image fusion are described below.

In some examples, the super resolution processing engine 728 can perform image alignment of the 12 MP binned input image 723 and the 48 MP remosaiced input image 724 prior to performing the image fusion on the images. For example, as described in more detail below, a transform can be computed for one of the 12 MP binned input image 723 or the 48 MP remosaiced input image 724. The transform can be used to shift and rotate one of the 12 MP binned input image 723 or the 48 MP remosaiced input image 724 in order to bring that image in alignment with the other one of the 12 MP binned input image 723 or the 48 MP remosaiced input image 724.

In some examples, the fused image 729 can be output by the super resolution processing engine 728 to a processing device (e.g., the ISP 154), not shown. In some examples, the fused image 729 (e.g., in some cases after being processed by a processing device, such as the ISP 154) can be output to an image coding engine (not shown). The image coding engine can perform compression of the fused image 729 and can store the compressed image and/or can transmit the compressed image to another device. The coding engine can use any suitable image coding technology, such as Joint Photographic Experts Group (JPEG) coding, Joint Bilevel Image Group (JBIG), Graphics Interchange Format (GIF), Portable Network Graphics (PNG), and/or other coding technique.

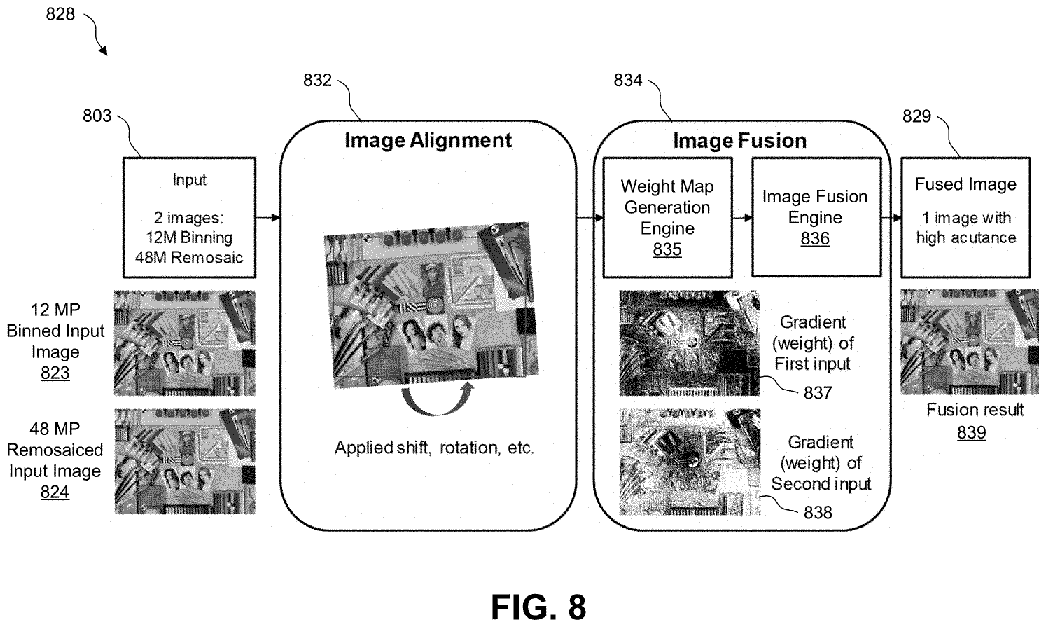

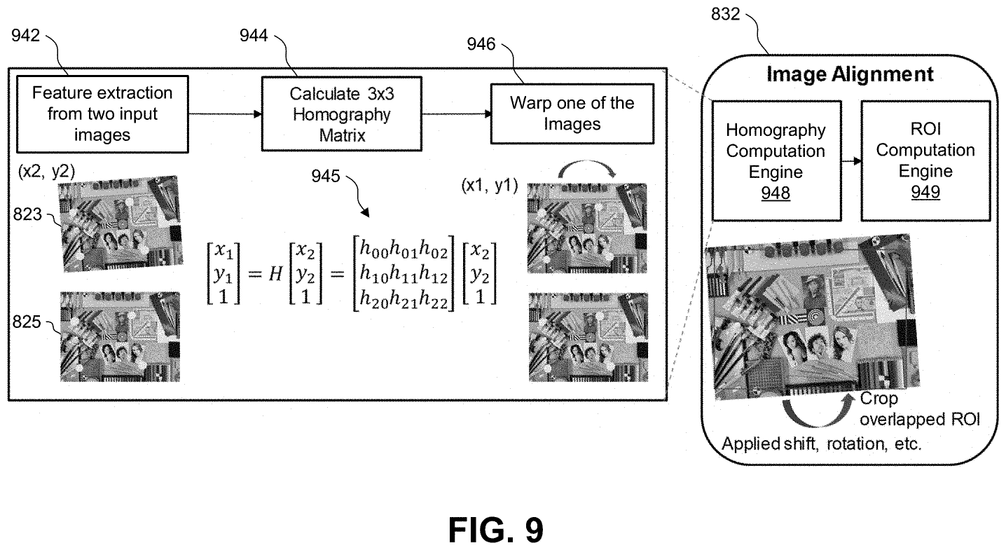

FIG. 8 is a diagram illustrating an example of a super resolution processing engine 828. The super resolution processing engine 828 includes an image alignment system 832 and an image fusion system 834. The input 803 to the image alignment system 832 includes two images, including the 12 MP binned input image 823 and the 48 MP remosaiced input image 824. As noted above, the 12 MP binned input image 823 can include a noise reduced 12 MP binned image (after being processed using MFNR) or can include a 12 MP binned image after the binning process is performed (without performing MFNR). Similarly, the 48 MP remosaiced input image 824 can include a noise reduced 48 MP remosaiced image (after being processed using MFNR) or can include a 48 MP remosaiced image after the remosaicing process is performed (without performing MFNR). In some examples, the image alignment system 832 can downsample the 48 MP remosaiced input image 824 so that it has a 12 MP resolution. In some examples, the image alignment system 832 can upsample the 12 MP binned input image 823 so that it has a 48 MP resolution. In some cases, the image alignment system 832 can downsample the 48 MP remosaiced input image 824 and upsample the 12 MP binned input image 823 to a common resolution. In one illustrative example, the common resolution can be 24 MP. The 12 MP binned input image 823 and the reduced (e.g., downsampled) 12 MP remosaiced input image 824 (or the upsampled 48 MP binned input image 823 and the 48 MP remosaiced input image 824) can be aligned by the image alignment system 832 before providing the aligned images to the image fusion system 834 for fusion. Operations of the image alignment system 832 are describe below with respect to FIG. 9.

FIG. 9 is a diagram illustrating an example of components and operation of the image alignment system 832. As shown in FIG. 9, the image alignment system 832 includes a homography computation engine 948 and a region of interest (ROI) computation engine 949. Before aligning the image, the image alignment system 832 can either downsample the 48 MP remosaiced input image 824 to 12 MP resolution, or can upsample the 12 MP binned input image 823 so that it has a 48 MP resolution. Any suitable downsampling or upsampling technique can be used, such as linear interpolation techniques. For illustrative purposes, the example illustrated in FIG. 9 will be described as aligning the 12 MP binning input image 823 and a 12 MP remosaiced input image 825 (generated by downsampling the 48 MP remosaiced input image 824).

The homography computation engine 948 can perform operations 942, 944, and 946. For example, at operation 942, the homography computation engine 948 performs feature extraction from the two input images, including the 12 MP binned input image 823 and the 12 MP remosaiced input image 825. The feature extraction can be performed using one or more feature detection and/or recognition algorithms to extract certain distinct features from the input images 823 and 825. The extracted features can be used as reference points by which to align the input images 823 and 825. In one illustrative example, if the input images 823 and 825 include images of a table, the extracted features can include the four corners of the table. The feature points on the four corners of the table in the 12 MP binned input image 823 can be aligned with the feature points on the four corners of the table in the 12 MP remosaiced input image 825.

In some implementations, the feature detection and/or recognition algorithms used for operation 942 can include and/or incorporate an image detection and/or recognition algorithm, a feature detection and/or recognition algorithm, an edge detection algorithm, a boundary tracing function, an object detection and/or recognition algorithm, a facial detection and/or recognition algorithm. or some combination thereof. Feature detection is a technology used to detect (or locate) features of objects from an image or video frame. For instance, feature detection can identify a number of edges and corners in an area of the scene. In some implementations, one or more computer vision-based feature extraction technique can be used, such as using Histogram of oriented gradients (HOG), Speeded-up robust features (SURF), Local binary patterns (LBP), Haar wavelets, Color histograms, any combination thereof, and/or other computer vision techniques. In some implementations, the feature detection and/or recognition algorithm can be based on a machine learning model trained to extract features from images. For instance, the machine learning model can be a neural network (NN), such as a convolutional neural network (CNN), a time delay neural network (TDNN), a deep feed forward neural network (DFFNN), a recurrent neural network (RNN), an auto encoder (AE), a variation AE (VAE), a denoising AE (DAE), a sparse AE (SAE), a markov chain (MC), a perceptron, or some combination thereof. The machine learning model may be trained using supervised learning techniques, unsupervised learning techniques, semi-supervised learning techniques, any combination thereof, Generative adversarial network (GAN) training techniques, and/or other machine learning training techniques.

As shown in FIG. 9, four corresponding detected features are determined from the two input images 823 and 825 (shown in FIG. 9 as dots or points in the input images 823 and 825). At operation 944, the homography computation engine 948 calculates a homography matrix. For example, the homography computation engine 948 can determine a homography transform represented as a transform matrix (e.g., the 3×3 homography matrix 945) between the planes of the two input images 823 and 825. A 3×3 homography matrix 945 is shown in FIG. 9 as an illustrative example. Other homography matrix sizes can be used in other examples.

At operation 946, one of the input images (either the 12 MP binned input image 823 or the 12 MP remosaiced input image 825) is warped (or wrapped) based on the calculated transform matrix (e.g., the 3×3 homography matrix 945). For instance, using the homography matrix 945 (or transform), the features of the 12 MP binned input image 823 and the features of the 12 MP remosaiced input image 825 can be registered with one another. Referring to FIG. 9, after applying the homography matrix based alignment, the four dots or points shown over the input images 823 and 825 can be overlapped with one another. In the illustrated example, each pixel of the 12 MP binned input image 823 are scaled and rotated to align with the 12 MP remosaiced input image 825. The example shown in FIG. 9 illustrates the 12 MP binned input image 823 being scaled and rotated using the homography matrix 945 so that coordinates of a feature point are changed from a position of (x2, y2) (representing a (horizontal coordinate, vertical coordinate)) to a position of (x1, y1). It should be understood that either one of the two inputs images can be scaled and rotated to align with the other of the two input images without departing from the scope of the present disclosure.

Because the image content of one of the input images 823 or 825 is warped (or wrapped) to register the points of the input images 823 and 825, the image boundaries of the input images 823 and 825 may not be aligned. The ROI computation engine 949 can cut or crop (referred to as image cropping) the overlapped image content and can use the overlapped portion as new output images that will be provided for processing by the image fusion system 834. In some implementations, the cropped images can be resized to a size that matches the resolution of the original input images. For example, when the two input images have a resolution of 12 MP (e.g., input images 823 and 825), the cropped image(s) (one or both of which may have had pixels removed by the image cropping) can be scaled back up to 12 MP. In some implementations, the cropped images can be resized to the original input image sizes. For example, the cropped binned image can be resized to a resolution of 12 MP, and the cropped remosaiced image can be resized to a resolution of 48 MP.

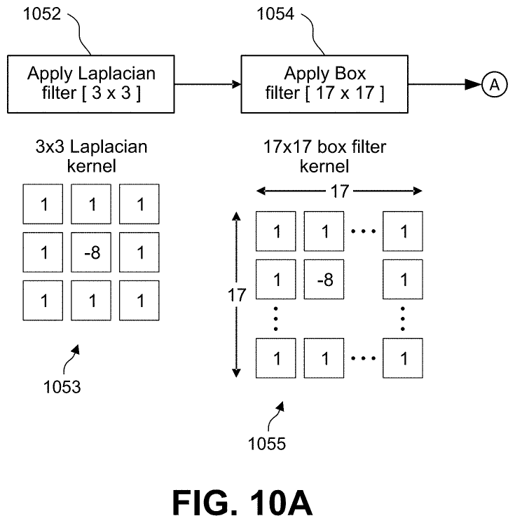

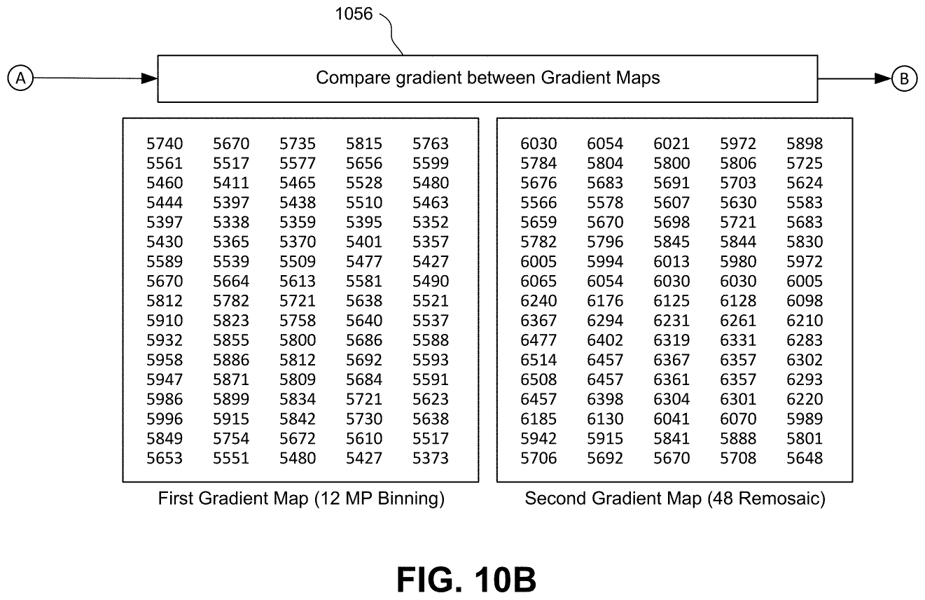

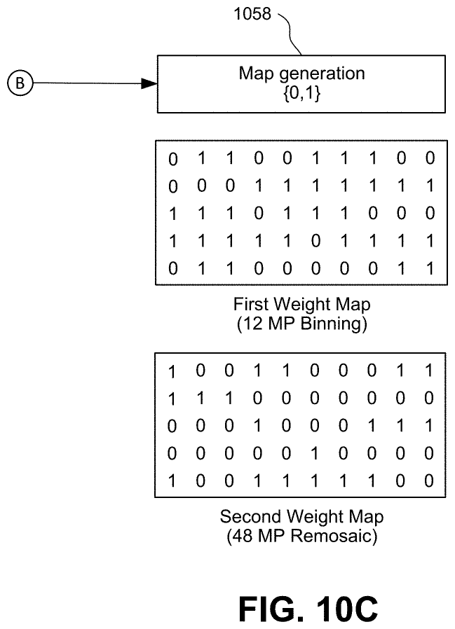

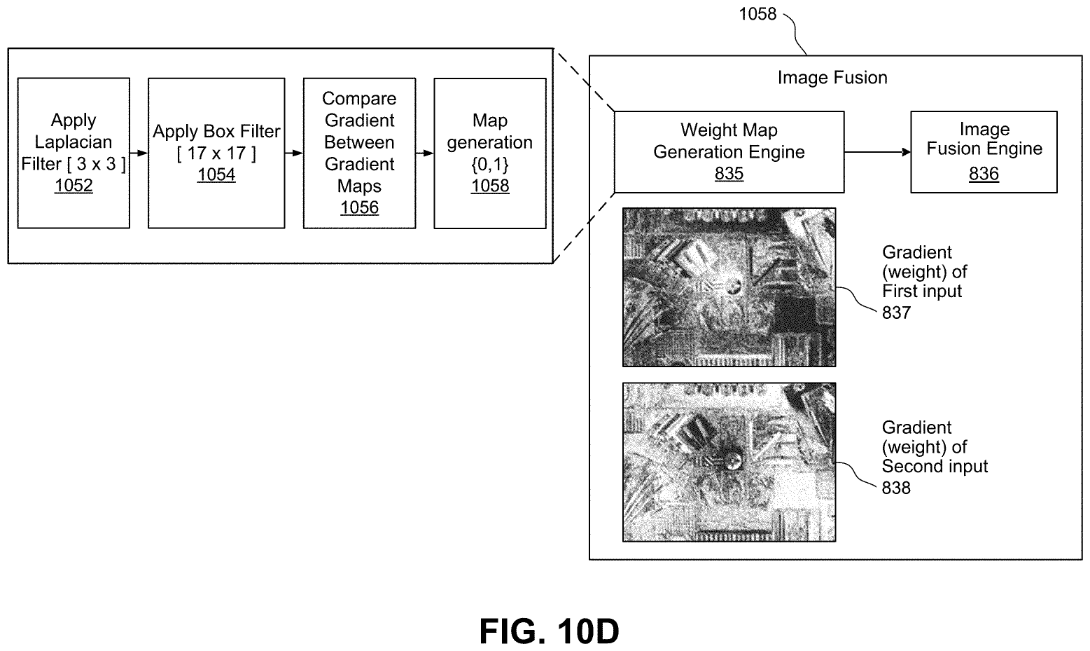

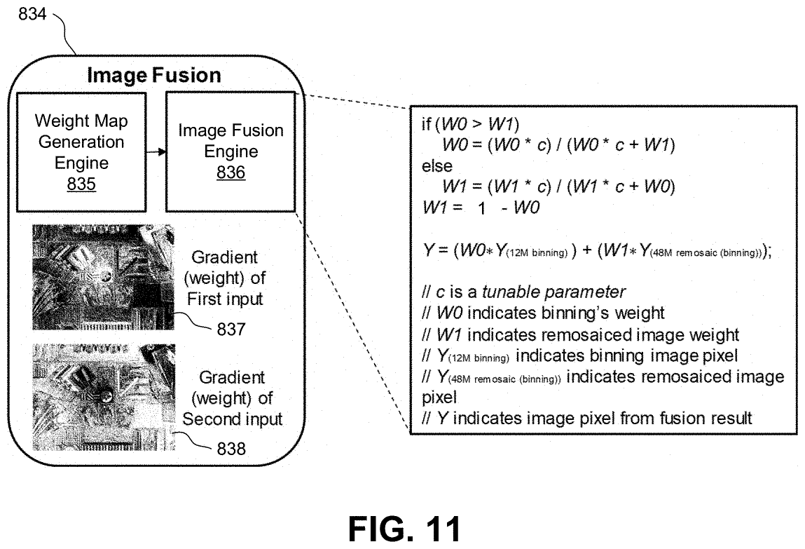

After aligning and resizing the input images 823 and 825, the aligned 12 MP binned input image 823 and the aligned 12 MP remosaiced input image 825 (or, in some cases the aligned 48 MP remosaiced input image 824) are provided to the image fusion system 834 for generation of the fused image 829. As illustrated in FIG. 8, the image fusion system 834 includes a weight map generation engine 835 and an image fusion engine 836. The weight map generation engine 835 can generate one or more weight maps, and the image fusion engine 836 can use the one or more weight maps to determine which pixels from the 12 MP binned input image 823 and which pixels from the 12 MP remosaiced input image 825 (or the 48 MP remosaiced input image 824) to use for generating the fused image 829. The one or more weight maps can be generated based on characteristics of the input images 823 and 825 (or 824). Gradient will be used as an example of the characteristics, such as in the examples described below with respect to FIG. 10A through FIG. 10D and FIG. 11. For example, as shown in FIG. 8, a weight map 837 can be generated for the 12 MP binned input image 823 and a weight map 838 can be generated for the 12 MP remosaiced input image 825 (or the 48 MP remosaiced input image 824). In some implementations, one or more other characteristics of the input images 823 and 825 (or 824) can be used to generate the one or more weight maps. As shown in FIG. 8, an example fusion result 839 (e.g., a fused image 829) can be formed by the image fusion system 834 based on the 12 MP binned input image 823 and the 12 MP remosaiced input image 825 (or the 48 MP remosaiced input image 824).

FIG. 10A, FIG. 10B, FIG. 10C, and FIG. 10D are diagrams illustrating example operations of the weight map generation engine 835 of the image fusion system 834. At operation 1052 of FIG. 10A, the weight map generation engine 835 obtains and applies a Laplacian filter to the 12 MP binned input image 823 and to the 12 MP remosaiced input image 825 (or the 48 MP remosaiced input image 824). An example of a 3×3 Laplacian filter 1053 (also referred to as a kernel) is shown in FIG. 10A. Other Laplacian filter sizes (e.g., 5×5, 7×7, etc.) can be used in other implementations. The Laplacian filter is used by the weight map generation engine 835 to detect edges in the input images 823 and 825 (or 824). At operation 1054 of FIG. 10A, the weight map generation engine 835 obtains and applies a box filter to the 12 MP binned input image 823 and to the 12 MP remosaiced input image 825 (or the 48 MP remosaiced input image 824). An example of a 17×17 box filter 1055 (or kernel) is shown in FIG. 10A. Other box filter sizes can be used in other implementations. The box filter is used to smooth the edges in the input images 823 and 825 (or 824) detected by the Laplacian filter.

The Laplacian filter and the box filter can be used to extract gradient maps for the input images 823 and 825 (or 824). For example, the Laplacian and box filters can both be applied as convolutions on the input images 823 and 824 to generate an output gradient value for each pixel of the 12 MP binned input image 823 and for each pixel of the 12 MP remosaiced input image 825 (or the 48 MP remosaiced input image 824). For instance, the Laplacian filter can be convolved around the 12 MP binned input image 823 one pixel at a time. When being applied to a given pixel, the middle position of the filter kernel (shown with a value of −8 in FIG. 10A) is placed over the pixel being filtered. After being applied to the given pixel, the filter can be moved to a next pixel. The Laplacian filter can be applied to every pixel of the 12 MP binned input image 823 or can be applied to less than all pixels in some cases. A similar process can be performed to apply the Laplacian filter to the 12 MP remosaiced input image 825 (or the 48 MP remosaiced input image 824). The box filter can also be convolved around each of the input images 823 and 825 (or 824), resulting in an output gradient value being generated for each pixel of the input images 823 and 825 (or 824). In some implementations where the gradient map is extracted from the 48 MP remosaiced input image 824, the filter can combine neighboring pixels to generate a weight map for the 48 MP remosaiced input image 824 that is the same size as the weight map generated for the 12 MP binned input image 823. Although the example operation 1052 above described the weight map generation engine 835 obtaining and applying a Laplacian filter, other edges filters, including but not limited to a Sobel filter, a Canny edge detector, Gaussian derivative edge detectors, a Prewitt filter, any combination thereof and/or other filters and/or edge detectors can be used without departing from the scope of the present disclosure.

The output gradient values are included in a gradient map for each of the 12 MP binned input image 823 and the 48 MP remosaiced input image 824. As shown in FIG. 10B, a first gradient map is generated for the 12 MP binned input image 823 and a second gradient map is generated for the 48 MP remosaiced input image 824. In some examples, a gradient value is included in the first gradient map for each pixel of the 12 MP binned input image 823 (for a total of 12,000,000 gradient values) and a gradient value is included in the second gradient map for each pixel of the 12 MP remosaiced input image 825 (for a total of 12,000,000 gradient values) In some examples, a gradient value is included in the first gradient map for each pixel of the 12 MP binned input image 823 (for a total of 12,000,000 gradient values), and a gradient value is included in the second gradient map for each pixel of the 48 MP remosaiced input image 824 (for a total of 48,000,000 gradient values). In some examples, when the size of the gradient maps differs, the gradient maps can be made to have an equal size by upscaling the smaller gradient map (e.g., the gradient map with fewer gradient values) or downscaling the larger gradient map (e.g., the gradient map with more gradient values). Only a subset of the gradient values of each gradient map are shown in FIG. 10B.

At operation 1056 of FIG. 10B, the weight map generation engine 835 compares the gradient values from the first gradient map and the second gradient map. At operation 1058 of FIG. 10C, based on the comparison, the weight map generation engine 835 can generate a first weight map for the 12 MP binned input image 823 and a second weight map for the 12 MP remosaiced input image 825 (or for the 48 MP remosaiced input image 824). For example, based on the detected gradient values from the two input images 823 and 825 (or 824), the weight map generation engine 835 compares each gradient from a corresponding or common location of the two gradient maps. For example, the top-left most value in the first gradient map and the top-left most location in the second gradient map can be considered as a location (0, 0) in the first and second gradient maps. A next location to the right of location (0, 0) can be considered as location (0, 1), a next location can be considered as location (0, 2), and so on. A location below the location (0, 0) can be considered as location (1, 0), a next location below location (1, 0) can be considered as location (2, 0), and so on.

The weight map generation engine 835 can determine which gradient value for a particular common location in the first and second gradient maps has the larger value. Based on the comparison, a value for the first and second weight maps is determined. The weight maps can be binary weight maps, with a first binary value being added to a weight map if the value in the corresponding gradient map is determined to be the larger gradient value and a second binary value being added to a weight map if the value in the corresponding gradient map is determined to be the lower gradient value. In one illustrative example, the larger gradient value is changed to a normalized value of 1, which is added to a corresponding location in the weight map. The gradient value that has the lower value is changed to normalized value of 0 and included at the corresponding location in the weight map.

In one illustrative example using the notation above, the gradient value at location (0, 0) in the first gradient map (the top-left location shown in FIG. 10B with a value of 5740) can be compared to the gradient value at location (0, 0) in the second gradient map (the top-left location shown in FIG. 10B with a value of 6030). The gradient value of 5740 at the location (0, 0) in the first gradient map is lower than the gradient value of 6030 at the location (0, 0) in the second gradient map, and thus the first weight map includes a normalized value of 0 at location (0, 0) and the second weight map includes a normalized value of 1 at location (0, 0). The weight map 837 and the weight map 838 shown in FIG. 8 and FIG. 10C illustrate the weight maps as binary images (with a white pixel corresponding to a normalized value of 1 and black pixel corresponding to a value of 0). The brighter regions in the weight maps 837 and 838 indicate more textures between the two input images.

As described above, the weight map generation engine 835 can generate two binary weight maps with each pixel having a first binary value (e.g., a value of 0) or a second binary value (e.g., a value of 1). The values in a corresponding location of the two binary weight maps are inverses of one another because of the above mentioned technique of assigning the first binary value (e.g., 0) to the smaller gradient value and the second binary value (e.g., 1) to the larger gradient value (e.g., if a value at a location in the first binary weight map is assigned a value of 1, the corresponding value at the location in the second weight map must be 0).

Because of the inverse relationship, a single weight map can be generated for one of the input images 823 or 824, and the weight values can be determined for the other of the input images 823 or 824 by determining the inverse of each value from the weight map. For example, if a weight map is only generated for the 12 MP binning image 823 and a value at location (0, 0) in the weight map is 1, the corresponding weight value for the 12 MP remosaiced input image 825 (or the 48 MP remosaiced input image 824) can be determined to be a value of 0. In some implementations, the first value assigned to each pixel in the first weight map and the second value assigned to each pixel in the second weight map are not limited to having values of 0 and 1. In one illustrative example, the value assigned to the smaller gradient value can be 0.2 and the value assigned to the larger gradient value can be 0.8.

In some implementations, rather than assigning the first value in the first weight map to the smaller gradient and the second value in the second weight map to the larger gradient as described above, the weight map generation engine 835 can assign weights for the pixel locations based on the proportions of the gradient values in the first gradient map and the second gradient map. For example, if the gradient value in the first gradient map at location (0,0) is equal to the gradient value in the second gradient map at location (0, 0), the corresponding values in the first weight map and the second weight map can both be equal to 0.5.

The values in the first weight map and the second weight map of FIG. 10C can be used as weights by the image fusion engine 836 for combining the pixels of the 12 MP binning image 823 and the pixels of the 12 MP remosaiced input image 825 (or the 48 MP remosaiced input image 824). FIG. 11 is a diagram illustrating example operations of the image fusion engine 836 and of the image fusion system 834. The image fusion system 834 uses the first and second weight maps to fuse the two input images 823 and 825 (or 824). The weight values from the first and second weight maps can be used to choose the pixels from the input images 823 and 825 (or 824) with the larger gradient values to generate a new fused image 829.

The term W0 in FIG. 11 refers to a weight from the first weight map of the 12 MP binned input image 823, and the term W1 refers to a weight from the second weight map of the 12 MP remosaiced input image 825 (or of the 48 MP remosaiced input image 824). The value of W0 and W1 is either 0 or 1 (or other first and second values), as described above. As noted above, W0 and W1 for a given location in the weight maps are inverses of one another. For instance, if W0 is 1 for a given location (e.g., location (5, 5)) in the first weight map, W1 is 0 for the corresponding location (e.g., location (5, 5)) in the second weight map. The term c in FIG. 11 is a tuning parameter that can include a constant value (e.g., a value of 0.001 or other value), the term Y_{(12M binning)} is a pixel from the 12 MP binned input image 823, the term Y_{(48M remosaic(binning))} is a corresponding pixel from the 48 MP remosaiced input image 824 (at a same location as the Y_{(12M binning)} pixel), and the term Y is a pixel that results from the fusion operation and that will be included in the fused image 829. The tuning parameter c can be set to a small value (e.g., 0.001) to avoid the denominator of the image fusion formulation from becoming zero. The image fusion formulation is shown in FIG. 11 as follows:

$$Y = ( W 0 * {Y}_{( 12 M binning )} ) + ( W 1 * {Y}_{( 48 M remosaic ( binning ) )} ) , where W 0 = \frac{( W 0 * c )}{( W 0 * c + W 1 )}$$

A result of the fusion formulation is that the pixel with the larger gradient value (as indicated by a weight value of 1 in the weight map for that image) will be selected or determined for the fused image 829. In one illustrative example, for a given location in the first and second weight maps, the value in the first weight map (for the 12 MP binned input image 823) can be larger than the corresponding value in the second weight map (for the 48 MP remosaiced input image 824), in which case W0 is a weight value of 1 and W1 is a weight value 0. Because W0>W1 (assuming c=0.001, Y_{(12M binning)}=200, and Y_{(48M remosaic(binning))}=150), the following formulation can be determined:

$$W 0 = \frac{( W 0 * c )}{( W 0 * c + W 1 )} = \frac{( 1 * 0.001 )}{( 1 * .0001 + 0 )} = 1 and Y = ( W 0 * {Y}_{( 12 M binning )} ) + ( W 1 * {Y}_{( 48 M remosaic ( binning ) )} = ( 1 * 200 ) + ( 0 *$$

As a result, the pixel from a particular location the 12 MP binned input image 823 (e.g., a location (0, 0)) can be selected for use in the fused image 829. A similar determination can be made for all other pixels of the fused image 829, resulting in the pixels in the fused image 829 being selected from both the 12 MP binned input image 823 and the 12 MP remosaiced input image 825 (or the 48 MP remosaiced input image 824). The fused image has high acutance while also having good contrast characteristics based on combining the advantages of the 12 MP binned input image 823 and the 12 MP remosaiced input image 825 (or the 48 MP remosaiced input image 824).

In another example, the value of W0 is a weight value of 0.8 and the value of W1 is a weight value of 0.2. Because W0>W1 and assuming c=0.5, Y_{(12M binning)}=200, and Y_{(48M remosaic(binning))}=150, the resulting value of Y=183. If the value of the tuning parameter c is instead tuned to c=0.2, the resulting value of Y=172.

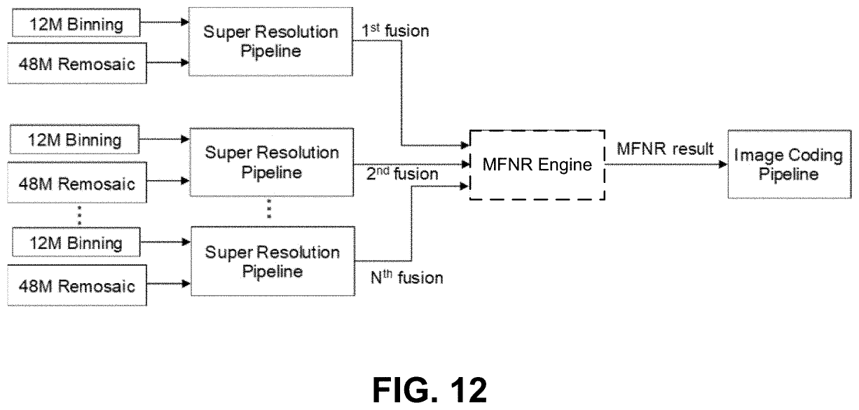

FIG. 12-FIG. 14 are diagrams illustrating additional features that can be included in the super resolution image fusion system. For example, FIG. 12 is a diagram illustrating an example of a system that can be used to extend the image fusion system from the YUV color domain (with a luminance component (Y) and two chrominance components U (blue projection) and V (red projection)) to the Bayer domain (the red-green-blue (RGB) color domain). As shown in FIG. 12, the image fusion process is performed by the super resolution processing engine in the Bayer domain. Each pair of binned and remosaiced images is shown in FIG. 12 as being processed by a respective super resolution processing pipeline. For instance, the input images can include 2×2 binned images (captured using a Bayer color filter array) and full size (e.g., 48 MP) remosaiced images (captured using a Bayer color filter array). After gathering multiple fusion results (shown in FIG. 12 as 1^{st} fusion result, 2^{nd} fusion result, and 3^{rd} fusion result), MFNR can be applied to obtain better SNR. The MFNR result can be provided to an image coding pipeline for storage and/or transmission. A benefit of performing the image fusion in the Bayer domain is that much detail can be preserved in the YUV domain without loss of detail in the image that can be caused by some modules in the ISP pipeline, such as demosiacing, noise reduction, etc.

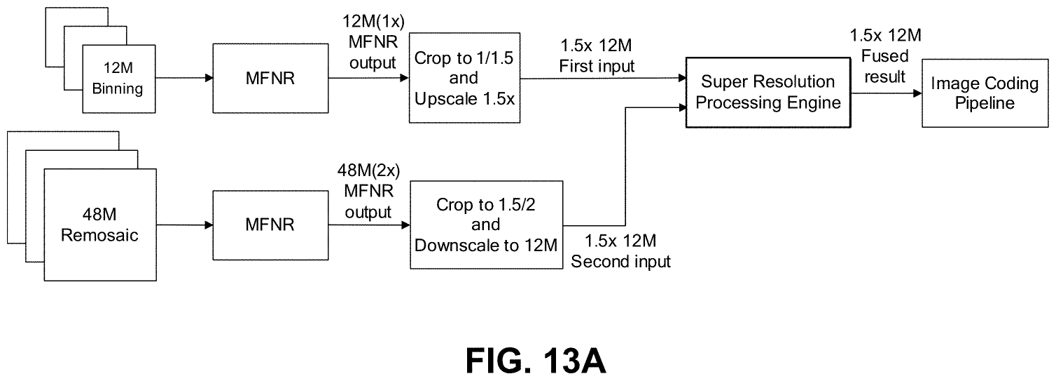

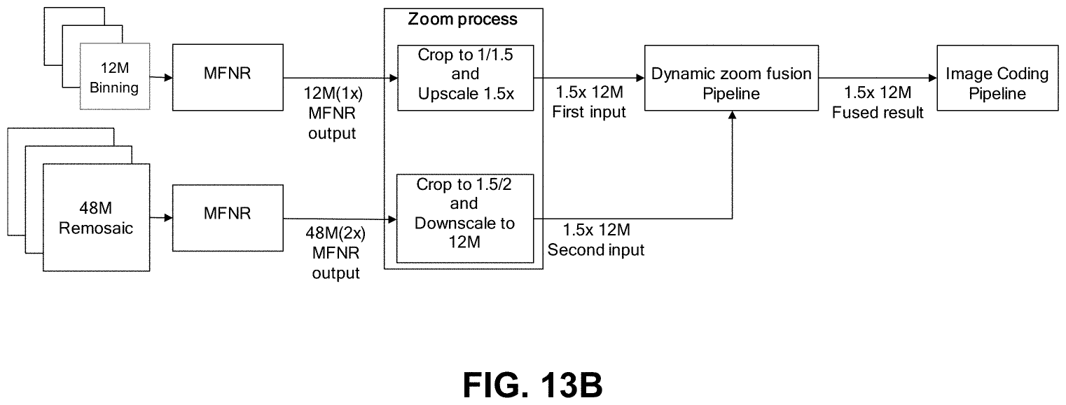

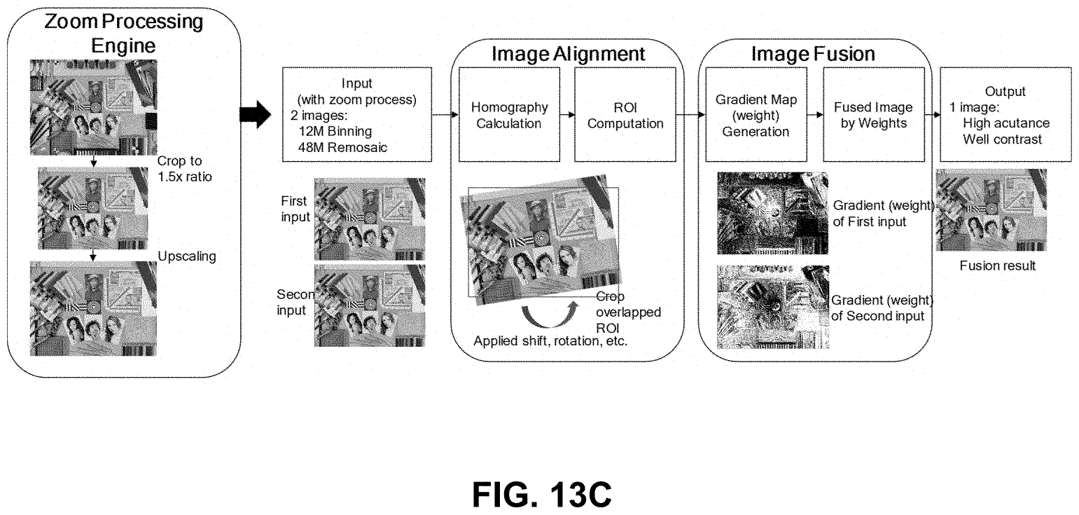

FIG. 13A, FIG. 13B, and FIG. 13C are diagrams illustrating an example of a system that can extend the image fusion system to be used for cases in which zoom is performed. The example shown in FIG. 13A, FIG. 13B, and FIG. 13C uses a 12M binned image and a 48M remosaiced image in a 1.5× zoom case. For example, in zoom cases, a binned image can be cropped and upscaled (or upsampled) to the original size with zoom. The cropped and upscaled binned image can be fused or blended with a remosaiced image that is cropped and downscaled (or downsampled) to the same size and scale as the binned image. A benefit of such a solution is that more details can be obtained from the remosaiced image in the zoom case.

In one example, a user can provide user input associated with a zoom command indicating the user wants to enlarge (or shrink) the image to a different ratio (e.g., from 1.1× to 1.99×). In this case, the field of view (FOV) is different in the 12 MP binning image as compared to the 48 MP remosaiced image. The FOV of the 12 MP binning is larger, and the FOV of the 48M remosaiced image is smaller. The system shown in FIG. 13A, FIG. 13B, and FIG. 13C can modify the 12 MP binning image and/or the 48 MP remosaiced image to make the image size and FOV identical (or within a threshold difference) between the two images. Because the FOV of the 12 MP image is larger than the 48 MP image, the object in the 12 MP binning image appears smaller than the same object in the 48 MP remosaiced image. Because of this, the system can upscale (enlarge) the 12 MP binning image. Similarly, because the FOV of the 48 MP remosaiced image is smaller than the 12 MP binning image, the object appears bigger than the corresponding object in the 12 MP binning image. The system can thus downscale the 48 MP remosaiced image so that the size of object is identical (or within a threshold distance) to the size of the object in the 12 MP binning image. For fusing the 12 MP and 48 MP images, the size of the two images (the number of pixels) should be the same. The cropping process is used to cut or crop the overlapped region of both images.

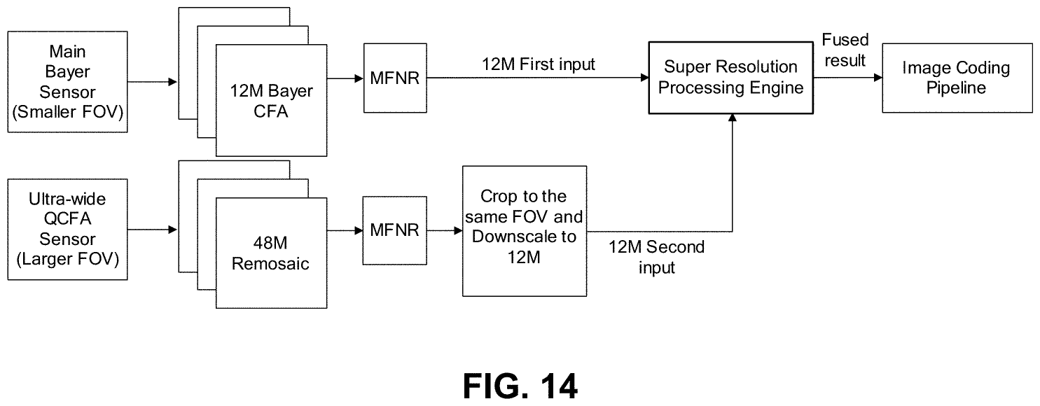

The super resolution image fusion techniques described herein are not limited to a single sensor. FIG. 14 is a diagram illustrating an example of a system that can extend the image fusion system from being used for a single image sensor to being used for multiple image sensors (e.g., for devices that include multiple cameras). The example shown in FIG. 14 uses a 12M binned image and a 48M remosaiced image from an ultra-wide sensor. For instance, if a first camera sensor of a device (e.g., a main camera sensor) does not use a quad color filter array (e.g., the sensor uses a Bayer color filter array) and one or more other sensors of the device (e.g., a ultra-wide sensor) use a quad color filter array, an image from the first camera sensor can be fused by the super resolution processing engine with a remosaiced image (from a sensor of the one or more other sensors). In cases in which an ultra-wide sensor (which has a larger field of view (FOV) than standard sensors) is used, as in the example of FIG. 14, the remosaiced image from the larger FOV sensor can be cropped to the same FOV as the first camera sensor. A benefit of such a solution is that in-sensor super resolution fusion can still be used for better detail preserving in multiple sensors.

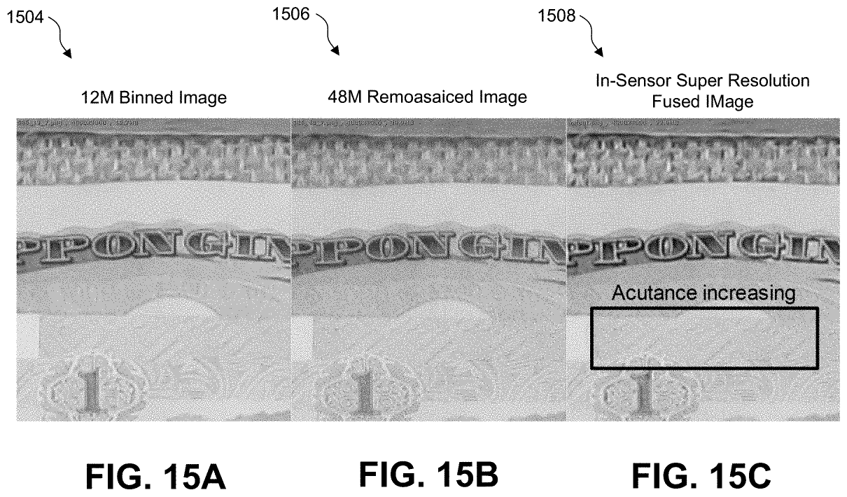

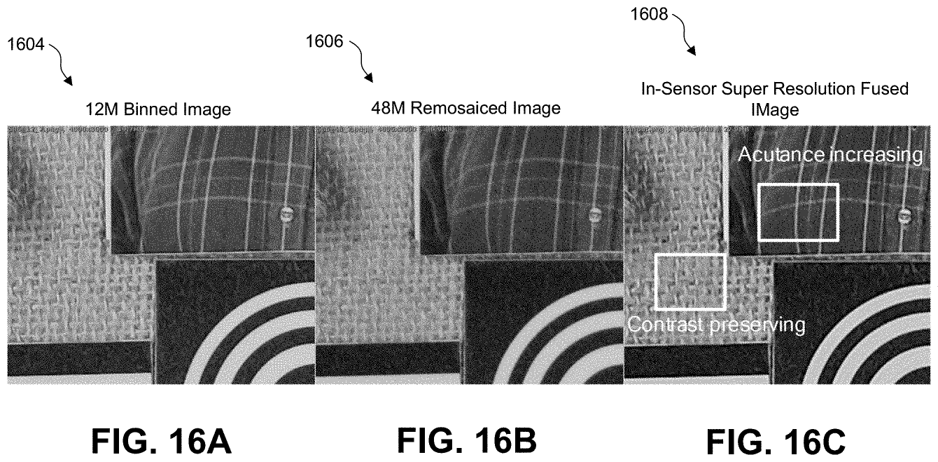

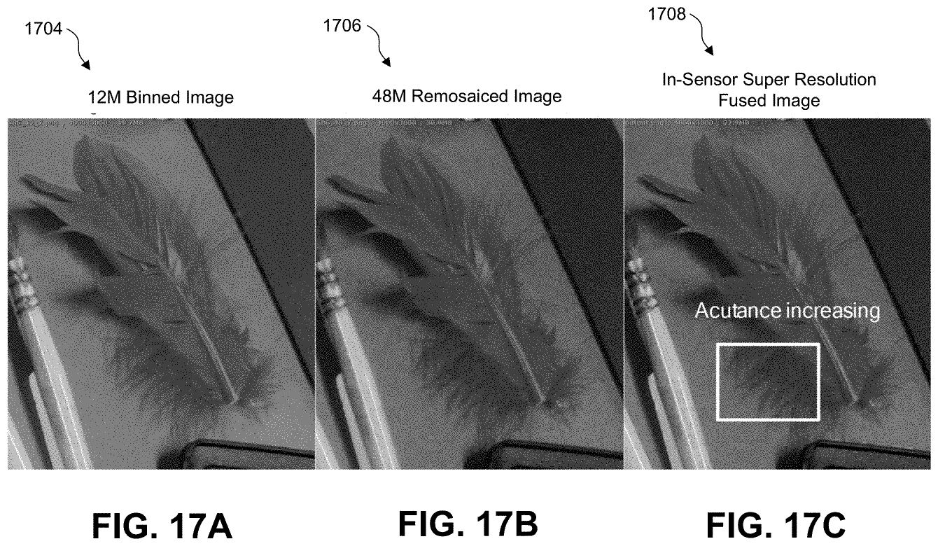

FIG. 15A-FIG. 15C, FIG. 16A-FIG. 16C, and FIG. 17A-FIG. 17C are images illustrating results of performing the image fusion techniques described herein. As noted above, the image fusion techniques effectively combine the benefit of different resolutions generated using the quad color filter array, resulting in a fused image that has high clarity. The acutance is effectively increased (as compared to typical binning images) while preserving the contrast. For example, a 12 MP binned image 1504 is shown in FIG. 15A and a 48 MP remosaiced image 1506 is shown in FIG. 15B. A fused image 1508 is shown in FIG. 15C that is generated by combining the 12 MP binned image 16504 and the 48 MP remosaiced image 1506. As can be seen, the fused image 1508 has increased acutance (as compared to the 12 MP binned image 1504).

FIG. 16A shows a 12 MP binned image 1604 and FIG. 16B shows a 48 MP remosaiced image 1606. A fused image 1608 is shown in FIG. 16C that is generated by combining the 12 MP binned image 1604 and the 48 MP remosaiced image 1606. As can be seen, the fused image 1608 has increased acutance (as compared to the 12 MP binned image 1604) while still preserving contrast between edges in the image.

FIG. 17A shows a 12 MP binned image 1704 and FIG. 17B shows a 48 MP remosaiced image 1706. FIG. 17C shows a fused image 1708 that is generated by combining the 12 MP binned image 1704 and the 48 MP remosaiced image 1706. As can be seen in FIG. 17C, the fused image 1708 has increased acutance as compared to the 12 MP binned image 1704.

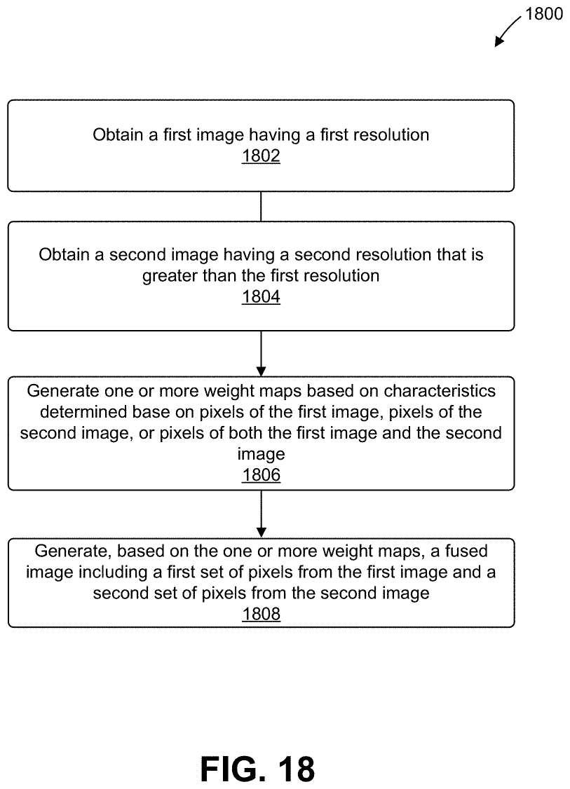

FIG. 18 is a flowchart illustrating an example of a process 1800 of processing image data using the techniques described herein. At block 1802, the process 1800 includes obtaining a first image having a first resolution. In some aspects, the first image is generated based on a pixel binning process, such as the pixel binning process described above. At block 1804, the process 1800 includes obtaining a second image having a second resolution that is greater than the first resolution. In some aspects, the second image is generated based on a remosaicing process. In one example, the first image has a resolution of 12 MP and the second image has a resolution of 48 MP. The first and second images can have any other resolution, which can be defined by the particular image sensor and/or device being used. In some cases, the first image and the second image are obtained from a same image sensor. In some cases, the first image and the second image are obtained from different image sensors.

In some examples, the process 1800 includes generating the first image by applying the pixel binning process to a first set of received image data. For instance, in some cases, generating the first image by applying the pixel binning process to the first set of received image data includes obtaining the first set of received image data, where the first set of received image data is captured using a quad color filter array. Multiple red pixels from the quad color filter array are merged into a single red pixel, multiple green pixels from the quad color filter array are merged into a single green pixel, and multiple blue pixels from the quad color filter array are merged into a single blue pixel.

In some examples, the process 1800 includes generating the second image by applying the remosaicing process to a second set of received image data. For instance, in some cases, generating the second image by applying the remosaicing process to the second set of received image data includes obtaining the second set of received image data (where the second set of received image data is captured using a quad color filter array) and converting the quad color filter array to a Bayer array.

At block 1806, the process 1800 includes generating one or more weight maps based on characteristics determined for pixels of the first image, pixels of the second image, or pixels of both the first image and the second image. In some examples, the characteristics include respective gradient values for the pixels of the first image and the pixels of the second image. In such examples, the one or more weight maps include values representative of the respective gradient values for the pixels of the first image and the pixels of the second image. In some cases, a motion map can be used. For instance, as described above, a motion map can be combined with the gradient map to determine which pixel(s) is/are selected. In some cases, the motion map can be generated by calculating the difference between two input images. In some examples, the values of the one or more weight maps (representing the respective gradient values for the pixels of the first image and the pixels of the second image) are normalized values generated based on the respective gradient values for the pixels of the first image and the pixels of the second image.

In some examples, as noted above, the characteristics include respective gradient values for the pixels of the first image and the pixels of the second image. In such examples, generating the one or more weight maps can include determining a first weight map for the first image and determining a second weight map for the second image. The first weight map includes a respective value representative of a respective gradient value determined for each pixel of the first image, and the second weight map includes a respective value representative of a respective gradient value determined for each pixel of the second image. In some implementations, the process 1800 includes generating the first weight map and the second weight map based on comparing a gradient value for each pixel from the first image with a gradient value for each corresponding pixel from the second image.

For instance, the gradients of corresponding pixels from two input images can be compared, and a larger weight can be included in a weight map for a particular pixel of an image when the gradient of that pixel is larger than a corresponding pixel in the other image. In one illustrative example, if a gradient value for a pixel of the first image is larger than a gradient value for a pixel of the second image (for a common pixel location in the first and second images), a weight value of 1 can be included in the first weight map and a weight value of 0 can be included in the second weight map. In another illustrative example, the process 1800 includes comparing a first gradient value of a first pixel of the first image and a second gradient value of a second pixel of the second image and determining the first gradient value is greater than the second gradient value. Based on determining the first gradient value is greater than the second gradient value, the process 1800 assigns a first value to a first location in the first weight map and a second value to a second location in the second weight map. In some aspects, the first value indicates use of the first pixel from the first image in the fused image (e.g., based on the first value, the first pixel will be used in the fused image). In some aspects, the first value indicates a higher weighting assigned to the first pixel of the first image relative to the second pixel of the second image in the fused image.

In some examples, the process 1800 includes downsampling the second image to the first resolution and aligning the first image and the downsampled second image. A weight map of the one or more weight maps can then be generated using the downsampled second image. In some cases, the first image can be upsampled to the second resolution and the images can be aligned. In such cases, the weight map can be generated using the upsampled first image.

In some examples, aligning the first image and the downsampled second image includes extracting one or more feature points from the first image and one or more feature points from the downsampled second image, and determining a shift and a rotation using a transform matrix, the one or more feature points from the first image, and the one or more feature points from the downsampled second image. The shift and the rotation can then be applied to one of the first image or the second image to align the first image and the second image.

At block 1808, the process 1800 includes and generating a fused image including a first set of pixels from the first image and a second set of pixels from the second image. The fused image is generated using the techniques described herein. In some examples, the process 1800 includes determining, based on the one or more weight maps, the first set of pixels from the first image and the second set of pixels from the second image. In some examples, the first set of pixels are determined or selected from the first image based on the one or more weight maps including highest weight values for the first set of pixels, and the second set of pixels are determined or selected from the second image based on the one or more weight maps including highest weight values for the second set of pixels.

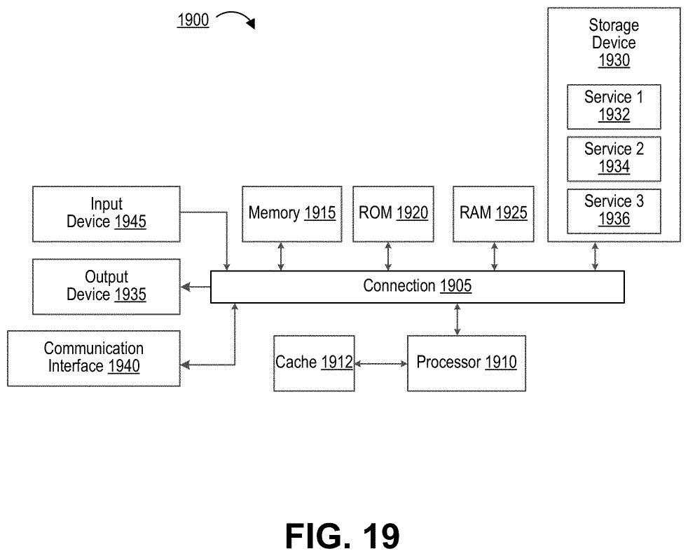

In some examples, the processes described herein (e.g., process 1800 and/or other process described herein) may be performed by a computing device or apparatus. In one example, the process 1800 can be performed by the image capture and processing system 100 of FIG. 1. In another example, the process 1800 can be performed by the image sensor 130 of FIG. 1 (e.g. implementing by the super resolution processing engine 728). In another example, the process 1800 can be performed by the ISP 154 of FIG. 1 (e.g. implementing by the super resolution processing engine 728). In another example, the process 1800 can be performed by the computing system 1900 (e.g., implementing by the super resolution processing engine 728) shown in FIG. 19.

The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a television, and/or any other computing device with the resource capabilities to perform the processes described herein, including the process 500. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 1800 is illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1800 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 19 is a diagram illustrating an example of a system for implementing certain aspects of the present technology. In particular, FIG. 19 illustrates an example of computing system 1900, which can be for example any computing device making up internal computing system, a remote computing system, a camera, or any component thereof in which the components of the system are in communication with each other using connection 1905. Connection 1905 can be a physical connection using a bus, or a direct connection into processor 1910, such as in a chipset architecture. Connection 1905 can also be a virtual connection, networked connection, or logical connection.

In some embodiments, computing system 1900 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1900 includes at least one processing unit (CPU or processor) 1910 and connection 1905 that couples various system components including a memory unit 1915, such as read-only memory (ROM) 1920 and random access memory (RAM) 1925 to processor 1910. Computing system 1900 can include a cache 1912 of high-speed memory connected directly with, in close proximity to, or integrated as part of processor 1910.

Processor 1910 can include any general purpose processor and a hardware service or software service, such as services 1932, 1934, and 1936 stored in storage device 1930, configured to control processor 1910 as well as a special-purpose processor where software instructions are incorporated into the actual processor design. Processor 1910 may essentially be a completely self-contained computing system, containing multiple cores or processors, a bus, memory controller, cache, etc. A multi-core processor may be symmetric or asymmetric.

To enable user interaction, computing system 1900 includes an input device 1945, which can represent any number of input mechanisms, such as a microphone for speech, a touch-sensitive screen for gesture or graphical input, keyboard, mouse, motion input, speech, etc. Computing system 1900 can also include output device 1935, which can be one or more of a number of output mechanisms. In some instances, multimodal systems can enable a user to provide multiple types of input/output to communicate with computing system 1900. Computing system 1900 can include communications interface 1940, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1940 may also include one or more Global Navigation Satellite System (GNSS) receivers or transceivers that are used to determine a location of the computing system 1900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1930 can include software services, servers, services, etc., that when the code that defines such software is executed by the processor 1910, it causes the system to perform a function. In some embodiments, a hardware service that performs a particular function can include the software component stored in a computer-readable medium in connection with the necessary hardware components, such as processor 1910, connection 1905, output device 1935, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1: A method for processing image data, the method comprising: obtaining a first image having a first resolution; obtaining a second image having a second resolution that is greater than the first resolution; generating one or more weight maps based on characteristics determined based on pixels of the first image, pixels of the second image, or pixels of both the first image and the second image; and generating, based on the one or more weight maps, a fused image including a first set of pixels from the first image and a second set of pixels from the second image.

Aspect 2: The method of aspect 1, further comprising: determining, based on the one or more weight maps, the first set of pixels from the first image and the second set of pixels from the second image.

Aspect 3: The method of any one of aspects 1 or 2, wherein the first image is generated based on a pixel binning process and the second image is generated based on a remosaicing process.

Aspect 4: The method of any one of aspects 1 to 3, wherein the first image and the second image are obtained from a same image sensor.

Aspect 5: The method of any one of aspects 1 to 4, wherein the first image is obtained from a first image sensor and the second image is obtained from a second image sensor, different from the first image sensor.

Aspect 6: The method of any one of aspects 1 to 5, further comprising: downsampling the second image to the first resolution; and aligning the first image and the downsampled second image; wherein a weight map of the one or more weight maps is generated using the downsampled second image.

Aspect 7: The method of aspect 6, wherein aligning the first image and the downsampled second image includes: extracting one or more feature points from the first image and one or more feature points from the downsampled second image; determining a shift and a rotation using a transform matrix, the one or more feature points from the first image, and the one or more feature points from the second image; and applying the shift and the rotation to one of the first image or the downsampled second image to align the first image and the downsampled second image.

Aspect 8: The method of any one of aspects 1 to 5, further comprising: upsampling the first image to the second resolution; aligning the upsampled first image and the second image; and wherein a weight map of the one or more weight maps is generated using the upsampled first image.

Aspect 9: The method of any one of aspects 1 to 5, further comprising: upsampling the first image to a third resolution, different from the first and second resolutions, downsampling the second image to the third resolution; aligning the upsampled first image and the downsampled second image; and wherein a weight map of the one or more weight maps is generated using the upsampled first image or downsampled second image.

Aspect 10: The method of any one of aspects 1 to 9, wherein the characteristics include respective gradient values for the pixels of the first image and the pixels of the second image, and wherein the one or more weight maps include values representative of the respective gradient values for the pixels of the first image and the pixels of the second image.

Aspect 11: The method of aspect 10, wherein the values of the one or more weight maps are normalized values generated based on the respective gradient values for the pixels of the first image and the pixels of the second image.

Aspect 12: The method of any one of aspects 1 to 11, wherein the first set of pixels are selected from the first image based on the one or more weight maps including highest weight values for the first set of pixels, and wherein the second set of pixels are selected from the second image based on the one or more weight maps including highest weight values for the second set of pixels.

Aspect 13: The method of any one of aspects 1 to 12, wherein the characteristics include respective gradient values for the pixels of the first image and the pixels of the second image, and wherein generating the one or more weight maps includes: determining a first weight map for the first image, the first weight map including a respective value representative of a respective gradient value determined for each pixel of the first image; and determining a second weight map for the second image, the second weight map including a respective value representative of a respective gradient value determined for each pixel of the second image.

Aspect 14: The method of aspect 13, further comprising: generating the first weight map and the second weight map based on comparing a gradient value for each pixel from the first image with a gradient value for each corresponding pixel from the second image.

Aspect 15: The method of any one of aspects 13 or 14, further comprising: comparing a first gradient value of a first pixel of the first image and a second gradient value of a second pixel of the second image; determining the first gradient value is greater than the second gradient value; and based on determining the first gradient value is greater than the second gradient value, assigning a first value to a first location in the first weight map and a second value to a second location in the second weight map, the first value indicating use of the first pixel from the first image in the fused image.

Aspect 16: The method of any one of aspects 13 or 14, further comprising: comparing a first gradient value of a first pixel of the first image and a second gradient value of a second pixel of the second image; determining the first gradient value is greater than the second gradient value; and based on determining the first gradient value is greater than the second gradient value, assigning a first value to a first location in the first weight map and a second value to a second location in the second weight map, the first value indicating a higher weighting assigned to the first pixel of the first image relative to the second pixel of the second image in the fused image.

Aspect 17: The method of any one of aspects 1 to 16, further comprising generating the first image by applying a pixel binning process to a first set of received image data.

Aspect 18: The method of aspect 17, wherein generating the first image by applying the pixel binning process to the first set of received image data includes: obtaining the first set of received image data, the first set of received image data being captured using a quad color filter array; merging multiple red pixels from the quad color filter array into a single red pixel; merging multiple green pixels from the quad color filter array into a single green pixel; and merging multiple blue pixels from the quad color filter array into a single blue pixel.

Aspect 19: The method of any one of aspects 1 to 18, further comprising generating the second image by applying a remosaicing process to a second set of received image data.

Aspect 20: The method of aspect 19, wherein generating the second image by applying the remosaicing process to the second set of received image data includes: obtaining the second set of received image data, the second set of received image data being captured using a quad color filter array; and converting the quad color filter array to a Bayer array.

Aspect 21: An apparatus for processing image data, the apparatus comprising: a memory configured to store at least one image; and one or more processors coupled to the memory, the one or more processors configured to: obtain a first image having a first resolution; obtain a second image having a second resolution that is greater than the first resolution; generate one or more weight maps based on characteristics determined based on pixels of the first image, pixels of the second image, or pixels of both the first image and the second image; and generate, based on the one or more weight maps, a fused image including a first set of pixels from the first image and a second set of pixels pixels from the second image.

Aspect 22: wherein the one or more processors are configured to: determine, based on the one or more weight maps, the first set of pixels from the first image and the second set of pixels from the second image.

Aspect 23: wherein the first image is generated based on a pixel binning process and the second image is generated based on a remosaicing process.

Aspect 24: wherein the first image and the second image are obtained from a same image sensor.

Aspect 25: wherein the first image is obtained from a first image sensor and the second image is obtained from a second image sensor, different from the first image sensor.

Aspect 26: The apparatus of aspect any one of aspects 21 to 25, wherein the one or more processors are configured to: downsample the second image to the first resolution; and align the first image and the downsampled second image; wherein a weight map of the one or more weight maps is generated using the downsampled second image.

Aspect 27: The apparatus of aspect 26, wherein aligning the first image and the downsampled second image includes: extracting one or more feature points from the first image and one or more feature points from the second image; determining a shift and a rotation using a transform matrix, the one or more feature points from the first image, and the one or more feature points from the downsampled second image; and applying the shift and the rotation to one of the first image or the downsampled second image to align the first image and the second image.

Aspect 28: The apparatus of any one of aspects 21 to 25, further comprising: upsampling the first image to the second resolution; aligning the upsampled first image and the second image; and wherein a weight map of the one or more weight maps is generated using the upsampled first image.

Aspect 29: The apparatus of any one of aspects 21 to 25, further comprising: upsampling the first image to a third resolution, different from the first and second resolutions, downsampling the second image to the third resolution; aligning the upsampled first image and the downsampled second image; and wherein a weight map of the one or more weight maps is generated using the upsampled first image or downsampled second image.

Aspect 30: The apparatus of any one of aspects 21 to 29, wherein the characteristics include respective gradient values for the pixels of the first image and the pixels of the second image, and wherein the one or more weight maps include values representative of the respective gradient values for the pixels of the first image and the pixels of the second image.

Aspect 31: The apparatus of aspect 30, wherein the values of the one or more weight maps are normalized values generated based on the respective gradient values for the pixels of the first image and the pixels of the second image.

Aspect 32: The apparatus of any one of aspects 21 to 29, wherein the first set of pixels are selected from the first image based on the one or more weight maps including highest weight values for the first set of pixels, and wherein the second set of pixels are selected from the second image based on the one or more weight maps including highest weight values for the second set of pixels.

Aspect 33: The apparatus of any one of aspects 21 to 32, wherein the characteristics include respective gradient values for the pixels of the first image and the pixels of the second image, and wherein generating the one or more weight maps includes: determining a first weight map for the first image, the first weight map including a respective value representative of a respective gradient value determined for each pixel of the first image; and determining a second weight map for the second image, the second weight map including a respective value representative of a respective gradient value determined for each pixel of the second image.

Aspect 34: The apparatus of aspect 33, wherein the one or more processors are configured to: generate the first weight map and the second weight map based on comparing a gradient value for each pixel from the first image with a gradient value for each corresponding pixel from the second image.

Aspect 35: The apparatus of any one of aspects 33 or 34, wherein the one or more processors are configured to: compare a first gradient value of a first pixel of the first image and a second gradient value of a second pixel of the second image; determine the first gradient value is greater than the second gradient value; and based on determining the first gradient value is greater than the second gradient value, assign a first value to a first location in the first weight map and a second value to a second location in the second weight map, the first value indicating use of the first pixel from the first image in the fused image.

Aspect 36: The apparatus of any one of aspects 33 or 34, wherein the one or more processors are configured to: compare a first gradient value of a first pixel of the first image and a second gradient value of a second pixel of the second image; determine the first gradient value is greater than the second gradient value; and based on determining the first gradient value is greater than the second gradient value, assign a first value to a first location in the first weight map and a second value to a second location in the second weight map, the first value indicating a higher weighting assigned to the first pixel of the first image relative to the second pixel of the second image in the fused image.

Aspect 37: The apparatus of any one of aspects 21 to 36, wherein the one or more processors are configured to generate the first image by applying a pixel binning process to a first set of received image data.

Aspect 38: The apparatus of aspect 37, wherein generating the first image by applying the pixel binning process to the first set of received image data includes: obtaining the first set of received image data, the first set of received image data being captured using a quad color filter array; merging multiple red pixels from the quad color filter array into a single red pixel; merging multiple green pixels from the quad color filter array into a single green pixel; and merging multiple blue pixels from the quad color filter array into a single blue pixel.

Aspect 39: The apparatus of any one of aspects 21 to 38, wherein the one or more processors are configured to generate the second image by applying a remosaicing process to a second set of received image data.

Aspect 40: The apparatus of aspect 39, wherein generating the second image by applying the remosaicing process to the second set of received image data includes: obtaining the second set of received image data, the second set of received image data being captured using a quad color filter array; and converting the quad color filter array to a Bayer array.

Aspect 41: The apparatus of any one of aspects 21 to 40, wherein the apparatus is a mobile device or part of a mobile device.

Aspect 42: The apparatus of any one of aspects 21 to 41 further comprising a camera for capturing one or more images.

Aspect 43: The apparatus any one of aspects 21 to 42, further comprising a display for displaying one or more images.

Aspect 44: A non-transitory computer-readable medium having stored thereon instructions that, when executed by one or more processors, cause the one or more processors to perform any of the operations of methods 1 to 43.

Aspect 45: A apparatus for processing image data comprising means for performing any of the operations of methods 1 to 43.

What is claimed is:

1. A method of processing image data, the method comprising:
obtaining a first image having a first resolution;
obtaining a second image having a second resolution that is greater than the first resolution;
generating one or more weight maps based on characteristics determined based on pixels of the first image, pixels of the second image, or pixels of both the first image and the second image; and
generating, based on the one or more weight maps, a fused image including a first set of pixels from the first image and a second set of pixels from the second image.

2. The method of claim 1, further comprising:
determining, based on the one or more weight maps, the first set of pixels from the first image and the second set of pixels from the second image.

3. The method of claim 1, wherein the first image and the second image are obtained from a same image sensor.

4. The method of claim 1, wherein the first image is obtained from a first image sensor and the second image is obtained from a second image sensor, different from the first image sensor.

5. The method of claim 1, further comprising:
downsampling the second image to the first resolution;
aligning the first image and the downsampled second image; and
wherein a weight map of the one or more weight maps is generated using the downsampled second image.

6. The method of claim 5, wherein aligning the first image and the downsampled second image includes:
extracting one or more feature points from the first image and one or more feature points from the downsampled second image;
determining a shift and a rotation using a transform matrix, the one or more feature points from the first image, and the one or more feature points from the second image; and
applying the shift and the rotation to one of the first image or the downsampled second image to align the first image and the downsampled second image.

7. The method of claim 1, wherein the characteristics include respective gradient values for the pixels of the first image and the pixels of the second image, and wherein the one or more weight maps include values representative of the respective gradient values for the pixels of the first image and the pixels of the second image.

8. The method of claim 7, wherein the values of the one or more weight maps are normalized values generated based on the respective gradient values for the pixels of the first image and the pixels of the second image.

9. The method of claim 1, wherein the characteristics include respective gradient values for the pixels of the first image and the pixels of the second image, and wherein generating the one or more weight maps includes:
determining a first weight map for the first image, the first weight map including a respective value representative of a respective gradient value determined for each pixel of the first image; and
determining a second weight map for the second image, the second weight map including a respective value representative of a respective gradient value determined for each pixel of the second image.

10. The method of claim 9, further comprising:
generating the first weight map and the second weight map based on comparing a gradient value for each pixel from the first image with a gradient value for each corresponding pixel from the second image.

11. The method of claim 9, further comprising:
comparing a first gradient value of a first pixel of the first image and a second gradient value of a second pixel of the second image;
determining the first gradient value is greater than the second gradient value; and
based on determining the first gradient value is greater than the second gradient value, assigning a first value to a first location in the first weight map and a second value to a second location in the second weight map, the first value indicating use of the first pixel from the first image in the fused image.

12. The method of claim 9, further comprising:
comparing a first gradient value of a first pixel of the first image and a second gradient value of a second pixel of the second image;
determining the first gradient value is greater than the second gradient value; and
based on determining the first gradient value is greater than the second gradient value, assigning a first value to a first location in the first weight map and a second value to a second location in the second weight map, the first value indicating a higher weighting assigned to the first pixel of the first image relative to the second pixel of the second image in the fused image.

13. The method of claim 1, further comprising generating the first image by applying a pixel binning process to a first set of received image data.

14. The method of claim 13, wherein generating the first image by applying the pixel binning process to the first set of received image data includes:
obtaining the first set of received image data, the first set of received image data being captured using a quad color filter array;
merging multiple red pixels from the quad color filter array into a single red pixel;
merging multiple green pixels from the quad color filter array into a single green pixel; and
merging multiple blue pixels from the quad color filter array into a single blue pixel.

15. The method of claim 1, further comprising generating the second image by applying a remosaicing process to a second set of received image data.

16. The method of claim 15, wherein generating the second image by applying the remosaicing process to the second set of received image data includes:
obtaining the second set of received image data, the second set of received image data being captured using a quad color filter array; and
converting the quad color filter array to a Bayer array.

17. An apparatus for processing image data, comprising:
a memory configured to store at least one image; and
one or more processors coupled to the memory, the one or more processors configured to:
obtain a first image having a first resolution;
obtain a second image having a second resolution that is greater than the first resolution;
generate one or more weight maps based on characteristics determined based on pixels of the first image, pixels of the second image, or pixels of both the first image and the second image; and
generate, based on the one or more weight maps, a fused image including a first set of pixels from the first image and a second set of pixels from the second image.

18. The apparatus of claim 17, wherein the one or more processors are configured to:
determine, based on the one or more weight maps, the first set of pixels from the first image and the second set of pixels from the second image.

19. The apparatus of claim 17, wherein the first image and the second image are obtained from a same image sensor.

20. The apparatus of claim 17, wherein the first image is obtained from a first image sensor and the second image is obtained from a second image sensor, different from the first image sensor.

21. The apparatus of claim 17, wherein the one or more processors are configured to:
downsample the second image to the first resolution; and
align the first image and the downsampled second image;
wherein a weight map of the one or more weight maps is generated using the downsampled second image.

22. The apparatus of claim 21, wherein aligning the first image and the downsampled second image includes:
extracting one or more feature points from the first image and one or more feature points from the downsampled second image;
determining a shift and a rotation using a transform matrix, the one or more feature points from the first image, and the one or more feature points from the downsampled second image; and
applying the shift and the rotation to one of the first image or the second image to align the first image and the second image.

23. The apparatus of claim 17, wherein the characteristics include respective gradient values for the pixels of the first image and the pixels of the second image, and wherein the one or more weight maps include values representative of the respective gradient values for the pixels of the first image and the pixels of the second image.

24. The apparatus of claim 17, wherein the characteristics include respective gradient values for the pixels of the first image and the pixels of the second image, and wherein generating the one or more weight maps includes:
determining a first weight map for the first image, the first weight map including a respective value representative of a respective gradient value determined for each pixel of the first image; and
determining a second weight map for the second image, the second weight map including a respective value representative of a respective gradient value determined for each pixel of the second image.

25. The apparatus of claim 24, wherein the one or more processors are configured to:
generate the first weight map and the second weight map based on comparing a gradient value for each pixel from the first image with a gradient value for each corresponding pixel from the second image.

26. The apparatus of claim 24, wherein the one or more processors are configured to:
compare a first gradient value of a first pixel of the first image and a second gradient value of a second pixel of the second image;
determine the first gradient value is greater than the second gradient value; and
based on determining the first gradient value is greater than the second gradient value, assign a first value to a first location in the first weight map and a second value to a second location in the second weight map, the first value indicating use of the first pixel from the first image in the fused image.

27. The apparatus of claim 17, wherein the one or more processors are configured to generate the first image by applying a pixel binning process to a first set of received image data.

28. The apparatus of claim 27, wherein generating the first image by applying the pixel binning process to the first set of received image data includes:
obtaining the first set of received image data, the first set of received image data being captured using a quad color filter array;
merging multiple red pixels from the quad color filter array into a single red pixel;
merging multiple green pixels from the quad color filter array into a single green pixel; and
merging multiple blue pixels from the quad color filter array into a single blue pixel.

29. The apparatus of claim 17, wherein the one or more processors are configured to generate the second image by applying a remosaicing process to a second set of received image data.

30. The apparatus of claim 29, wherein generating the second image by applying the remosaicing process to the second set of received image data includes:
obtaining the second set of received image data, the second set of received image data being captured using a quad color filter array; and
converting the quad color filter array to a Bayer array.
